(19) United States
(12) Patent Application Publication
(10) Pub. No.: US 2008/0254341 A1
(43) Pub. Date: Oct. 16, 2008

(54) BATTERY INCLUDING A FLUID MANAGER

(76) Inventors: John C. Bailey, Columbia Station, OH (US); Steven D. Jones, North Ridgeville, OH (US); Richard A. Langan, Parma, OH (US); Matthew Cole, Vancouver (CA); John David Wyndham Madden, Vancouver (CA)

Correspondence Address: MICHAEL C. POPHAL;EVEREADY BATTERY COMPANY INC, 25225 DETROIT ROAD, P O BOX 450777, WESTLAKE, OH, 44145, US

(21) Appl. No.: 11/852,516

(22) Filed: Sep. 10, 2007

Related U.S. Application Data
(60) Provisional application No. 60/911,332, filed on Apr. 12, 2007.

(51) Int. Cl. H01M 2/02; H01M 8/00

(52) U.S. Cl. 429/35; 429/34

(57) ABSTRACT

An electrochemical cell having a fluid consuming electrode and a fluid regulating system for controlling the rate of entry of fluids into the cell. The fluid regulating system may include a valve for controlling the rate of entry of fluids into the cell and an actuator for operating the valve. The actuator comprises an ionic polymer that responds to changes in a potential applied across the actuator to open or close the valve. In one embodiment, the actuator comprises at least one conducting polymer. In one embodiment, the actuator comprises polypyrrole, at least one polypyrrole derivative, or mixtures of two of more thereof.

### CROSS-REFERENCE TO RELATED APPLICATIONS

This application is entitled to the benefit of and incorporates by reference essential subject matter disclosed in Provisional Patent Application No. 60/911,332 filed on Feb. 19, 2003.

### BACKGROUND OF THE INVENTION

The disclosed technology relates to fluid regulating systems for controlling the rate of entry of fluids, such as gases, into and out of electrochemical batteries and cells such as batteries and cells that employ fluid consuming electrodes, and to the batteries and cells in which such fluid regulating systems are used, particularly air-depolarized, air-assisted, and fuel cells and batteries. More particularly, the disclosed technology relates to actuators for operating a fluid regulating system to control entry of fluids into and out of batteries and cells.

Electrochemical battery cells that use a fluid, such as oxygen and other gases, from outside the cell as an active material to produce electrical energy, such as air-depolarized, air-assisted, and fuel cell battery cells, can be used to power a variety of portable electronic devices. For example, air enters into an air-depolarized or air-assisted cell, where it can be used as, or can recharge, the positive electrode active material. The oxygen reduction electrode promotes the reaction of the oxygen with the cell electrolyte and, ultimately, the oxidation of the negative electrode active material with the oxygen. The material in the oxygen reduction electrode that promotes the reaction of oxygen with the electrolyte is often referred to as a catalyst. However, some materials used in oxygen reduction electrodes are not true catalysts because they can be at least partially reduced, particularly during periods of relatively high rate of discharge.

One type of air-depolarized cell is a zinc/air cell. This type of cell uses zinc as the negative electrode active material and has an aqueous alkaline (e.g., KOH) electrolyte. Manganese oxides that can be used in zinc/air cell are capable of electrochemical reduction in concert with oxidation of the negative electrode active material, particularly when the rate of diffusion of oxygen into the air electrode is insufficient. These manganese oxides can then be reoxidized by the oxygen during periods of lower rate discharge or rest.

Air-assisted cells are hybrid cells that contain consumable positive and negative electrode active materials as well as an oxygen reduction electrode. The positive electrode can sustain a high discharge rate for a significant period of time, but through the oxygen reduction electrode, oxygen can partially recharge the positive electrode during periods of lower or no discharge, so oxygen can be used for a substantial portion of the total cell discharge capacity. This means the amount of positive electrode active material put into the cell can be reduced and the amount of negative electrode active material can be increased to increase the total cell capacity. Examples of air-assisted cells are disclosed in commonly assigned U.S. Pat. Nos. 6,383,674 and 5,079,106.

An advantage of air-depolarized, air-assisted, and/or fuel cells is their high energy density, since at least a portion of the active material of at least one of the electrodes comes from or is regenerated by a fluid (e.g., a gas) from outside the cell.

A disadvantage of these cells is that the maximum discharge rates they are capable of can be limited by the rate at which oxygen can enter the oxygen reduction electrode. In the past, efforts have been made to increase the rate of oxygen entry into the oxygen reduction electrode and/or control the rate of entry of undesirable gases, such as carbon dioxide, that can cause wasteful reactions, as well as the rate of water entry or loss (depending on the relative water vapor partial pressures outside and inside the cell) that can fill void space in the cell intended to accommodate the increased volume of discharge reaction products or dry the cell out, respectively. Examples of these approaches can be found in U.S. Pat. No. 6,558,828; U.S. Pat. No. 6,492,046; U.S. Pat. No. 5,795,667; U.S. Pat. No. 5,733,676; U.S. Patent Publication No. 2002/0150814; and International Patent Publication No. WO 02/35641. However, changing the diffusion rate of one of these gases generally affects the others as well. Even when efforts have been made to balance the need for a high rate of oxygen diffusion and low rates of CO₂ and water diffusion, there has been only limited success.

At higher discharge rates, it is more important to get sufficient oxygen into the oxygen reduction electrode, but during periods of lower discharge rates and periods of time when the cell is not in use, the importance of minimizing CO₂ and water diffusion increases. To provide an increase in air flow into the cell only during periods of high rate discharge, fans have been used to force air into cells (e.g., U.S. Pat. No. 6,500,575), but fans and controls for them can add cost and complexity to manufacturing, and fans, even micro fans, can take up valuable volume within individual cells, multiple cell battery packs and devices.

Another approach that has been proposed is to use valves to control the amount of air entering the cells (e.g., U.S. Pat. No. 6,641,947 and U.S. Patent Publication No. 2003/0186099), but external means, such as fans and/or relatively complicated electronics, can be required to operate the valves.

Yet another approach has been to use a water impermeable membrane between an oxygen reduction electrode and the outside environment having flaps that can open and close as a result of a differential in air pressure, e.g., resulting from a consumption of oxygen when the battery is discharging (e.g., U.S. Patent Publication No. 2003/0049508). However, the pressure differential may be small and can be affected by the atmospheric conditions outside the battery.

Commonly assigned U.S. Patent Publication No. 2005/0136321 discloses a valve that is operated by an actuator that responds to changes in a potential applied across the actuator to open and close the valve.

### SUMMARY OF THE INVENTION

The disclosed technology relates to a fluid regulating system in a battery or cell to adjust the rate at which the fluid can reach the cell's fluid consuming electrode. The fluid regulating system responds to changes in the cell potential. The fluid regulating system comprises an actuator that is suitable for opening and closing a valve according to changes in the cell's potential. In one aspect, the actuator may comprise an ionic polymer, such as a conducting polymer, that is capable of changing shape or dimension in response to changes in the cell's potential.

The disclosed technology further relates to a battery comprising: a cell housing having at least one fluid entry port; a first electrode disposed within the cell housing; a second electrode disposed within the cell housing; and a fluid regulating system disposed so as to selectively allow fluid to enter into the at least one fluid entry port, the fluid regulating system comprising: a valve for controlling the rate of passage of the fluid to one or both of the first and second electrodes, and an actuator for operating the valve, the actuator comprising at least one conducting polymer, at least one ionic polymer-metal composite, or combinations of two or more thereof.

The disclosed technology also relates to a battery comprising: a cell housing having at least one fluid entry port for the passage of a fluid into the cell housing; a first fluid consuming electrode disposed within the cell housing; a second electrode disposed within said cell housing; and a fluid regulating system disposed so as to selectively allow fluid to enter into the at least one fluid entry port so as to reach the first fluid consuming electrode, the fluid regulating system comprising: a valve for adjusting the rate of passage of the fluid into the fluid consuming electrode, the valve comprising an actuator overlying the at least one entry port, the actuator comprising (i) a first actuator layer comprising at least one conducting polymer, (ii) a second actuator layer comprising at least one conducting polymer, (iii) a separator disposed between the first and second actuator layers.

The disclosed technology further relates to a battery cell comprising: a housing comprising a plurality of entry ports arranged substantially in a first row; a first fluid consuming electrode disposed within the cell housing; a second electrode disposed within the cell housing; and a fluid regulating system, the fluid regulating system comprising a valve for adjusting the rate of passage of the fluid into the fluid consuming electrode, the valve comprising an actuator sheet comprising at least one conducting polymer, at least one ionic polymer-metal composite, or mixtures of two or more thereof, wherein the actuator sheet is dimensioned to cover the first row of entry ports when the valve is in a closed position, and the valve is moveable to an open position by applying a voltage across the actuator so as to cause at least a portion of the actuator sheet to be displaced away from at least one entry port.

The disclosed technology further relates to a battery comprising: at least one fluid consuming cell comprising: a cell housing comprising at least one fluid entry port for the passage of fluid into the cell, a first fluid consuming electrode disposed within the cell housing, and a second electrode within the cell housing; and a fluid regulating system comprising: a valve for adjusting the rate of passage of the fluid to the fluid consuming electrode, the valve comprising (i) a first plate having a first end and a second end opposite the first end, the first plate being stationary relative to the at least one fluid consuming electrode, and (ii) a second plate, the second plate being moveable relative to the first plate so as to open and close the valve, and an actuator system for operating the valve, the actuator system comprising (i) a first actuator for opening the valve, the first actuator having opposing ends, one end being attached to the second plate, and the other end being attached to the first plate adjacent the first end of the first plate, and (ii) a second actuator for closing the valve, the second actuator having opposing ends, one end of the second actuator being attached to the second plate, and the other end of the second actuator being attached to the first plate adjacent the second end of the first plate, wherein the first and second actuators each comprise at least one conducting polymer component. Alternatively, one end of each of the first and second actuators is be attached to the second (moveable) plate, while the other end of each of the actuators can be attached to another stationary component of the fluid regulating system, the cell, or the battery.

The disclosed technology further relates to a method of providing a battery cell, the method comprising: providing a cell housing comprising at least one fluid entry port; providing a first electrode material and disposing the first electrode material within the cell housing to form a first electrode; providing a second electrode material and disposing the second electrode material within the cell housing to form a second electrode; providing a fluid regulating system to control the entry of a fluid into the cell housing, the fluid regulating system comprising (i) a valve to control the rate of passage of the fluid to one or both of the first and second electrodes, and (ii) an actuator for operating the valve, the actuator comprising at least one conducting polymer, at least one ionic polymer-metal composite, or mixtures of two or more thereof; and positioning the fluid regulating system relative to the at least one fluid entry port so that the fluid regulating system may be operated for fluid communication with the at least one fluid entry port.

The disclosed technology further relates to an actuator comprising: a first actuating layer comprising at least one conducting polymer, at least one ionic polymer-metal composite, or mixtures of two or more thereof; a second actuating layer comprising at least one conducting polymer, at least one ionic polymer-metal composite, or mixtures of two or more thereof, a separator disposed between the first and second layers; and an encapsulation layer disposed about the first actuating layer and the second actuating layer.

The disclosed technology further relates to a method of encapsulating an actuator, the method comprising: providing an actuator comprising (i) a first actuating layer comprising at least one conducting polymer, at least one ionic polymer-metal composite, or mixtures of two or more thereof, (ii) a second actuating layer comprising at least one conducting polymer, at least one ionic polymer-metal composite, or mixtures of two or more thereof, and (iii) a separator layer disposed between the first and second actuating layers; and applying a coating layer about an outer layer of the first actuating layer and an outer layer of the second actuating layer.

These and other aspects of the disclosed technology will be further understood and appreciated by those skilled in the art by reference to the following specification, claims, and appended drawings.

### BRIEF DESCRIPTION OF THE DRAWINGS

In the drawings:

FIGS. 1A and 1B are cross-sectional views of a bending/flap actuator in accordance with one embodiment of the disclosed technology;

FIG. 2 is a cross-sectional view of an ionic polymer having a bilayer configuration;

FIG. 3 is a cross-sectional view of a bending/flap actuator employing ionic polymers having a bilayer configuration;

FIG. 4 is a perspective view of one embodiment of a battery in accordance with the disclosed technology;

FIG. 5 is a perspective view of the battery shown in FIG. 4 showing the bottom of the battery;

FIG. 6 is a cross-sectional view of the battery shown in FIGS. 4 and 5 taken along the line 6-6;

FIG. 7 is a top plan view of the interior portion of the can for the battery in FIGS. 4-6 showing the valve components, where the cover and remaining interior components have been removed;

FIGS. 8A and 8B are partial cross-sectional views illustrating the valves of the fluid regulating system in an open and closed position, respectively;

FIG. 9 is an enlarged view of one of the valves in FIG. 8B;

FIG. 10 is a partial cross-sectional view illustrating a valve of a fluid regulating system disposed outside of the battery's can;

FIG. 11 is a perspective view of a battery in accordance with one embodiment of the disclosed technology;

FIG. 12 is a perspective view of the battery shown in FIG. 11 showing the bottom of the battery;

FIG. 13 is an exploded perspective view showing the top of the battery and the interior of the can along with the components forming a fluid regulating system in accordance with one embodiment of the disclosed technology;

FIGS. 14A and 14B are partial cross-sectional views illustrating the valves of the fluid regulating system from the battery in FIG. 13 in an open and closed position, respectively;

FIGS. 15A and 15B are top plan views of the fluid regulating system shown in FIG. 13 in an open and closed position, respectively;

FIG. 16 is a top plan view of a fluid regulating system shown in FIG. 13 with an alternative arrangement for the actuator system;

FIGS. 17A and 17B are top plan views of a fluid regulating system as employed in FIG. 13 utilizing an alternative actuator system;

FIG. 18 is an exploded view of a fluid regulating system that may be used in the various embodiments of the disclosed technology;

FIG. 19 is an exploded perspective view of a battery in accordance with the disclosed technology, with the fluid regulating system actuators not shown;

FIG. 20 is a cross-sectional view of the fluid regulating system of the battery shown in FIG. 19, as viewed from the right side;

FIG. 21 is a cross-sectional view of a fluid regulating system in accordance with another embodiment of the invention;

FIGS. 22A, 22B, and 22C illustrate the operation of a bending/flap actuator valve as described in Example 1; and

FIGS. 23A and 23B illustrate another embodiment of a bending/flap actuator valve operating as described in Example 1;

FIGS. 24A and 24B are schematic representations of a valve operated by a linear actuator in accordance with Example 3.

### DETAILED DESCRIPTION OF THE PREFERRED EMBODIMENTS

Embodiments of the disclosed technology relate to a battery that includes an electrochemical cell that utilizes a fluid (such as oxygen or another gas) from outside the cell as an active material for at least one of the electrodes. The cell may include at least one fluid consuming electrode such as, for example, an oxygen reduction electrode. The cell can be, but is not limited to, an air-depolarized cell, an air-assisted cell, a fuel cell, or the like. The battery also has a fluid regulating system for controlling the rate of passage of fluid to the fluid consuming electrode (e.g., the air electrodes in air-depolarized and air-assisted cells) to provide a sufficient amount of the fluid from outside the cell for discharge of the cell at high rate or high power, while minimizing entry of fluids into the fluid consuming electrode and water gain or loss into or from the cell during periods of low rate or no discharge.

The fluid regulating system may have at least one of a fast response to changes in cell potential, a long cycle lifetime, a low operating voltage that is well matched to the cell voltage range on discharge, and/or a high efficiency. In addition, the regulating system may have a low permeability to the fluids being managed in the closed position, open and close in proportion to the need for the active fluid in the cell, require only a very small amount of the total cell discharge capacity, have a small volume, and/or be easy and inexpensive to manufacture and incorporate into or onto the cell.

As used herein, unless otherwise indicated, the term “fluid” refers to fluid that can be consumed by the fluid consuming electrode(s) of a fluid consuming cell in the production of electrical energy by the cell. While the disclosed technology is described below with reference to air-depolarized cells with oxygen reduction electrodes, the disclosed technology is not limited to use in such cells, and it will be appreciated that the disclosed technology can more generally be used in fluid consuming cells having other types of fluid consuming electrodes, such as, for example, fuel cells. Fuel cells can use a variety of gases from outside the cell housing as the active material of one or both of the cell electrodes.

As described further below with respect to the various exemplary embodiments, a battery in accordance with the disclosed technology includes a fluid consuming cell and a fluid regulating system. The fluid regulating system regulates or controls the flow of fluid to the fluid consuming electrode(s) of the fluid consuming cell. For an air-depolarized cell, the fluid regulating system may be disposed on the inside or outside of a cell housing of the fluid consuming cell and on the side of the oxygen reduction electrode. That is, the fluid regulating system may be disposed on, or on a part of, the surface of the oxygen reduction electrode that is accessible to air from the outside of the cell housing.

The fluid regulating system comprises a valve for controlling the rate of passage of the fluid to the fluid consuming electrode(s). The fluid regulating system may also comprise an actuator to operate the valve. In one embodiment, the actuator comprises a material that responds to changes in potential applied across the actuator.

The actuator may comprise a flexible material that can change shape as a result of internal stress or strain to apply sufficient force to operate the valve. Internal stress and strain can be created by a physical change within the actuator, such as a non-uniform volume change, or by a change in distribution of electrical charge within or on the surfaces of the actuator. Deformation of the actuator can be, for example, bending, straightening, elongation or expansion, or shortening or contraction. An example of a uniform volume change within the actuator is a relative increase in volume on one side of the actuator relative to the volume on the other side such as when the volume increases on one side and decreases on the other, increases on both sides, or increases more on one side than on the other. In such instances, the actuator can bend away from the side with the greater volume increases.

Non-uniform changes in volume can result from the movement of ions within the actuator, induced by changes in a potential applied across the actuator. For example, non-uniform changes in volume can occur when a relatively high concentration of ions of one size is created in one area of the actuator and a relatively high concentration of ions of a different size is created in another area. Areas of high ion concentration can be created and changed in a number of ways.

Suitable materials for the actuator include ionic polymers such as, for example, conducting polymers, ionic polymer-metal composites, or the like. In one embodiment, an actuator comprises at least one conducting polymer.

Actuators comprising ionic polymers generally behave as electrochemical cells, and generally include two electrodes separated by an electrolyte. For example, conducting polymers may serve as the electrodes in the actuator. Conducting polymers, for example, undergo a volume change as their oxidation state is changed. During oxidation, electrons are removed from the backbone of the polymer, and the charge is kept in balance by an influx of counter ions from the electrolyte. Since the conducting polymer must exchange electrons, a counter electrode is also employed; the counter electrode may be another conducting polymer. In one embodiment, an actuator comprises a first conducting polymer, a second conducting polymer, and an electrolyte. As a voltage is applied across the actuator, the first conducting polymer may be oxidized and the second conducting polymer may be reduced. The first conducting polymer loses electrons as it is oxidized, and anions from the electrolyte flow into the first polymer. The flow of ions into the polymer causes the polymer to swell or expand. The second conducting polymer gains electrons when it is reduced, and anions flow out of the second conducting polymer causing it to contract.

Generally, ionic polymers, such as conducting polymers, perform work during contraction rather than during expansion or relaxation. That is, ionic polymers generally accomplish work by pulling (contraction) rather than by pushing (expansion). Therefore, it may be desirable to employ at least two ionic polymer components in an actuator, one to perform work when a voltage is applied across the actuator, and one to perform work when the voltage is reversed.

### Fluid Regulating System Employing Bending/Flap Actuators

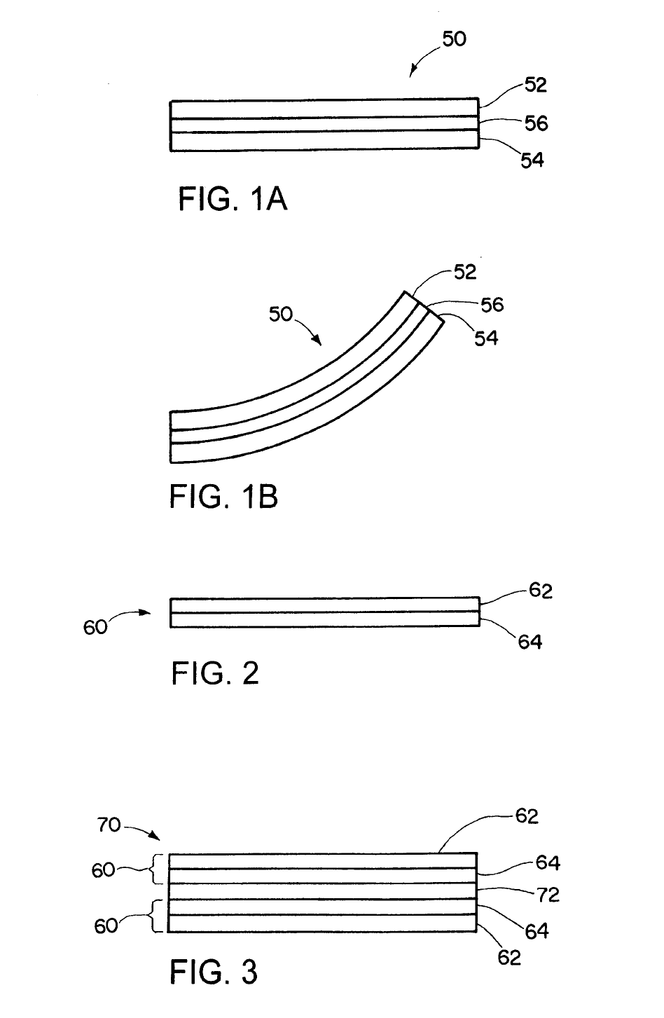

In one embodiment, an actuator may be configured as a structure capable of bending or flapping. An example of one embodiment of such an actuator is shown in FIGS. 1A and 1B. As shown in FIG. 1A-1B, actuator 50 comprises a first layer 52, a second layer 54, and a third layer 56 disposed between layer 52 and layer 54. In one embodiment, the first and second layers 52, 54 each comprise at least one conducting polymer, and the third layer 56 is generally a separator. With reference to FIG. 1B, as a potential is applied across the actuator, layer 52 contracts and layer 54 expands; the contraction of layer 52 causes the actuator to bend upwardly. The actuator can be made to bend in the other direction by reversing the potential.

In one embodiment, layers 52 and 54 each comprise at least one conducting polymer. In one embodiment, the same conducting polymer composition is employed in layers 52 and 54. In another embodiment, the layers 52 and 54 comprise (i) similar conducting polymers but of different compositions or concentrations, or (ii) different conducting polymers. In one embodiment, layers 52 and 54 each comprise at least one ionic polymer-metal composite.

In another embodiment, a bending/flapping actuator may employ an ionic polymer-metal composite. An actuator employing an ionic polymer-metal composite may also be represented by actuator 50 comprising first layer 52, second layer 54, and third layer 56. In this embodiment, however, layers 52 and 54 represent metal layers, and layer 56 represents a polymer layer. The polymer layer includes cations and water molecules and the metal layers generally serve as the electrodes. As a charge is applied across the ionic polymer-metal composite, hydrated cations migrate toward the negatively charged side, which results in an increase in volume along the negative electrode. The positively charged side contracts and the ionic polymer-metal composite bends. The structure may be made to bend in the opposite direction by reversing the potential. It will be appreciated that the metal layers may penetrate into the polymer layer, and there may not be a sharp boundary between the metal layers and the polymer layer.

Actuators having a configuration as shown in FIGS. 1A and 1B may be referred to as a trilayer or trimorph. Generally, a trilayer employing conducting polymers may be formed by providing a separator 56 and disposing layers 52 and 54 on opposite sides of separator 56. Layers 52 and 54 may be disposed on the separator by various methods including electrochemical deposition, electroless chemical deposition, or by chemically synthesizing films and then sandwiching the separator between the films. Bending/flap actuators formed by electrochemical deposition may include a thin deposition electrode layer disposed between the separator and each conducting polymer layer.

In one embodiment, an actuator may be formed from a conducting polymer having a bilayer configuration. As shown in FIG. 2, a bilayer 60 includes a backing layer 62 and a layer 64 comprising at least one conducting polymer. To provide suitable actuation for use in a valve in accordance with the disclosed technology, an actuator comprising a conducting polymer must be able to exchange ions, and an actuator employing a bilayer configuration generally comprises stacked bilayers separated by a separator. For example, with reference to FIG. 3, actuator 70 includes bilayers 60 disposed about separator 72. The bilayers are disposed about the separator such that conducting polymer layers 64 are disposed adjacent separator 72. Thus, while comprising bilayers 64, actuator 70 has a configuration that essentially resembles a trilayer.

A fluid regulating system for a battery may include a valve that is operated by an actuator that is capable of bending or flapping in response to a voltage change. In one embodiment, the bending actuator may form the valve. That is, in one embodiment, a bending or flap actuator may also function as the valve in regulating or controlling fluid entry into a cell.

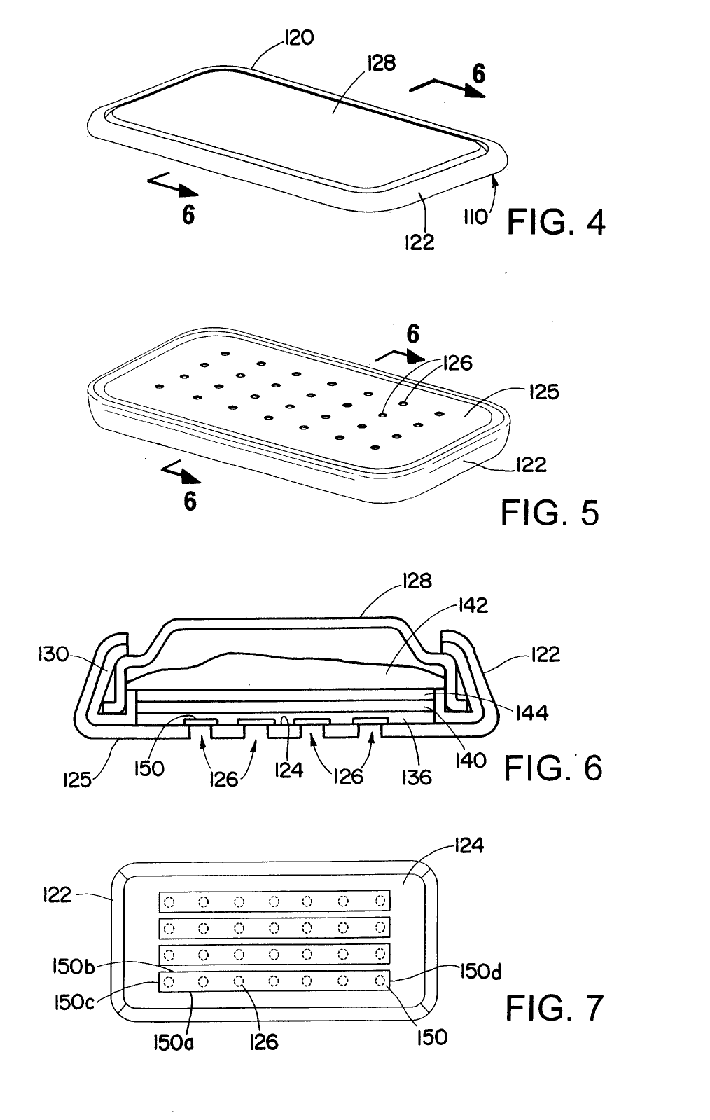

FIGS. 4-9 illustrate one embodiment of a battery comprising a fluid regulating system comprising a bending actuator. As shown, battery 100 includes a fluid consuming cell 110 (in this case an air-depolarized cell) having a cell housing 120. Cell housing 120 includes a first housing component and a second housing component, which may include a can 122 and a cover 128, respectively, or may have shapes or sizes differing from what would otherwise be considered a can or cover. For purposes of example, in this embodiment, the first housing component is hereinafter referred to as can 122, while the second housing component is hereinafter referred to as cover 128. Can 122 and cover 128 are both made of an electrically conductive material, but are electrically insulated from one another by means of a gasket 130 (FIG. 6). Can 122 generally serves as the external positive contact terminal for the fluid consuming cell 110, whereas cover 128 serves as the external negative contact terminal. Cell 110 further includes a first electrode 140, which may be the fluid consuming electrode or air electrode, a second electrode 142, which may be the negative electrode (i.e., anode), and a separator 144 disposed between the first and second electrodes (see, e.g., FIG. 6). In one embodiment, first electrode 140 is electrically coupled to can 122, and second electrode 142 is coupled to cover 128.

Can 122 includes an upper surface 124 and a bottom surface 125 in which a plurality of fluid entry ports 126 are provided such that fluid may pass to the interior of cell housing 120 so as to reach the fluid consuming electrode 140 (see FIG. 6). As shown in FIG. 6, the interior of cell housing 120 defines a space or region 136 between the top surface 124 of can 122 and the bottom surface of fluid consuming electrode 140.

As shown in FIGS. 4-10, cell 110 includes a fluid regulating system provided by a plurality of valves 150 disposed over a row of fluid entry ports 126. In this embodiment, the valve 150 is formed by the actuator itself, such as, for example, actuator 50 (FIGS. 1A, 1B) or 70 (FIG. 3) comprising at least one conducting polymer and/or at least one ionic polymer-metal composite. Generally, the valve is opened or closed by applying a potential across the actuator (which forms the valve) such that a portion of the valve is moved away from or towards the entry ports 126.

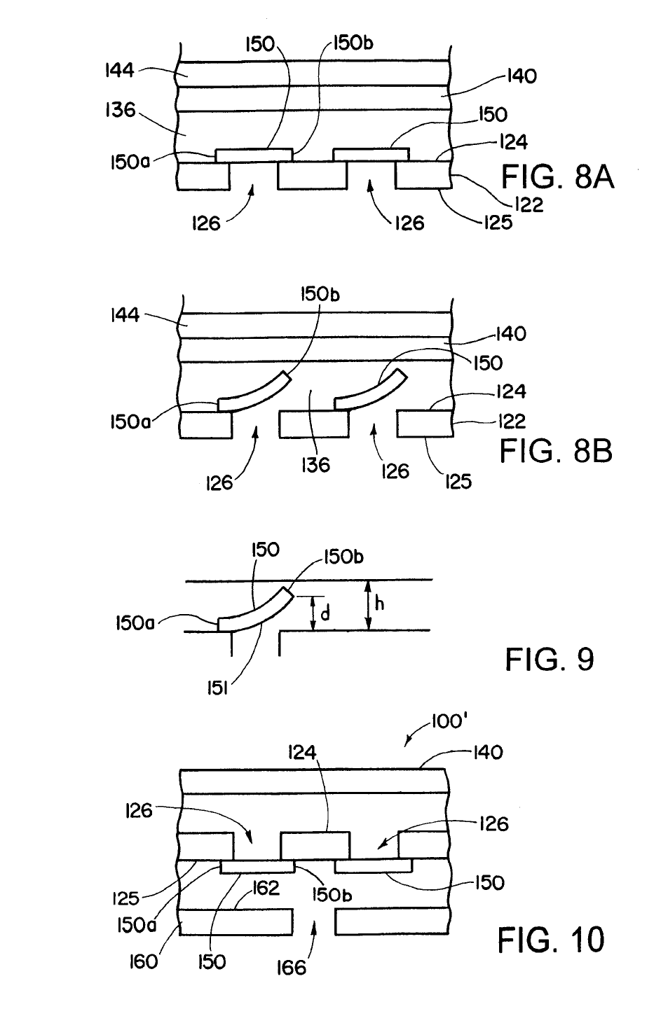

In one embodiment in FIGS. 4-9, a valve 150, which is formed by an actuator (e.g., actuator 50 or 70), is disposed about a row of apertures that define the fluid entry ports 126 (see FIG. 7). Valve 150 includes a first longitudinal edge 150a and a second longitudinal edge 150b, which are disposed generally parallel to the row of apertures over which the actuator is disposed. The bottom surface 151 of valve 150 is anchored at one or more points to the inner or top surface 124 of can 122 along longitudinal edge 150a of valve 150. As shown in FIG. 8A, valve 150 is in the closed position and substantially covers entry port 126 such that fluid cannot pass to the interior of cell housing 120. Upon application of a potential across the actuator/valve, the valve 150 bends and the longitudinal edge 150b is displaced away from surface 124 of can 122 such that at least a portion of at least one entry port is uncovered (FIG. 8B). When at least one entry port 126 is at least partially uncovered, air may flow through the entry port 126 and toward fluid consuming electrode 140. In one embodiment, longitudinal edge 150b is displaced away from surface 124 along longitudinal edge 150b such that at least one fluid entry port 126 in a given row is at least partially uncovered; in another embodiment, the displacement along longitudinal edge 150b is substantially uniform such that each entry port in a given row is uncovered to a similar degree.

It will be appreciated that the apertures and fluid entry ports may have any shape or size as selected for a particular use or intended application. Further, apertures may be arranged in any manner. The apertures may be arranged in rows or other patterns, or the apertures may be arranged in a random manner with no definite pattern. Further, an actuator may be dimensioned to overlay a plurality of rows.

The maximum displacement of valve 150 is the distance between surface 124 of plate 122 and the bottom surface 151 of valve 150 at the edge 150b of valve 150. The maximum displacement distance for a given application represents a fully open position of valve 150. The maximum displacement (d) of valve 150 is a function of the degree to which valve 150 can bend and the head space available in a given cell design. In one embodiment, the available head space (h) refers to the interior space or region 136, which is defined by the distance between fluid consuming electrode 140 and inner surface 124 of can 122. The amount of head space in a given cell may be selected as desired for a particular purpose or intended use. When not limited by the head space available in a given design, the displacement of a valve may be determined by the dimensions of the valve or actuator sheet and is governed by properties of the valve/actuator including the strain to charge ratio, the charge density, and the modulus and thickness of the various layers that form the actuator/valve.

It will be appreciated that valve 150 may be opened to a fully opened position, which may be determined by cell design, e.g., available head space, and/or the configuration or material employed in the actuator. Additionally, valve 150 may be opened to one or more open positions intermediate a fully open position and the closed position.

In one embodiment, a sealing material may be disposed between the bottom surface 151 of valve 150 and the surface 124 of can 122 to facilitate sealing between the valve 150 and surface 124 of can 122 when the valve is in a closed position. For example, an oil layer, e.g., silicone oil, may be disposed between a bottom surface 151 of valve 150 and surface 124 of can 122. In the closed position, the oil or sealing material pulls the valve down onto surface 124 of can 122 and slows gas or fluid diffusion. Upon application of a suitable voltage, valve 150 bends away from surface 124 and separates from surface 124 and the sealing material to allow fluid to flow through entry ports 126.

A valve formed by an actuator may be held in place or attached to a can in any suitable manner that allows for the valve to open. For example, valve 150 may be attached to surface 124 along longitudinal edge 150a by various means, including but not limited to, pressure bonding, melt bonding, adhesive bonding, and the like.

As shown in the embodiments in FIGS. 4-9, the fluid regulating system provided by valve 150 is shown as being incorporated in the interior of fluid consuming cell 110, and more particularly within the interior of can 122. It will be appreciated, however, that a valve 150 may be disposed outside can 122 such as along the bottom surface 125 of can 122. Such an embodiment is shown in FIG. 10. As shown in FIG. 10, the battery 100′ further includes a lid or cover plate 160 and holes 166 disposed therein to allow fluid to move toward entry ports 126. In this embodiment, valve 150 would open by bending away from surface 125 and toward surface 162 of lid 160 to expose entry ports 126. Fluid enters through holes 166 and then through entry ports 126 to reach fluid consuming electrode 140.

In one embodiment, valve 150 is formed from an actuator having a configuration along the lines of actuator 50 (FIG. 1) and comprising at least one conducting polymer, and/or at least one ionic polymer-metal composite. In one embodiment, the actuator comprises at least one conducting polymer. In one embodiment, the valve comprises polypyrrole, a polypyrrole derivative, or mixtures of two or more thereof. In one embodiment, the valve is formed from an actuator having a configuration along the lines of actuator 50 (FIG. 1), wherein layer 152 comprises a first conducting polymer and layer 154 comprises a second conducting polymer. In one embodiment, the first conducting polymer is the same as the second conducting polymer; in another embodiment, the first conducting polymer is different than the second conducting polymer.

A valve formed by an actuator is not limited to the embodiments described with respect to FIGS. 4-10. For example, in one embodiment, valve 150 could be attached to the surface 124 along a width-wise edge (e.g., edges 150a or 150b) of the valve. In such an embodiment, contraction occurs along the length of the valve/actuator and the opposing width-wise edge displaces from the surface. Other suitable embodiments of a valve formed by a bending/flap actuator include, but are not limited to, those disclosed in U.S. patent application Ser. No. 10/943,688 (printed as Publication No. 2005/0112427), which is incorporated by reference herein in its entirety.

A bending actuator may also be used in a fluid regulating system comprising a sliding plate valve. In one embodiment, a fluid regulating system may comprise (i) a valve comprising two or more plates each having one or more apertures, where the apertures of adjacent plates may be moved into varying degrees of alignment to allow for fluid to flow into the cell, and (ii) an actuator for operating the valve and moving at least one plate relative to an adjacent plate to move the apertures into or out of alignment. For example, the apertures may be moved into at least partial alignment by sliding or moving one plate relative to the adjacent plate with a linear, rotational or other motion. U.S. patent application Ser. No. 10/943,688 discloses a sliding plate valve that employs a bending actuator to operate the valve.

Fluid Regulating Systems Operated by Linear Actuators

In one embodiment, a fluid regulating system may comprise (i) a valve comprising two or more adjacent plates each having one or more apertures that may be moved into and out of alignment to regulate entry of fluid into the cell, and (ii) an actuator system comprising at least one actuating component that moves in a substantially linear direction to operate the valve, where the actuating component comprises at least one conducting polymer. In particular, a linear actuating component may comprise a sheet or film of a conducting polymer that contracts and/or expands substantially linearly if fixed to an object or objects at or near opposing ends of the actuator. In one embodiment, an actuator system may comprise at least two linear actuator components each comprising at least one conducting polymer; the actuator components may be immersed in an electrolyte and electrically connected to one another such that, when a voltage is applied across the actuator system, at least one actuator component contracts (and performs work) to operate the valve.

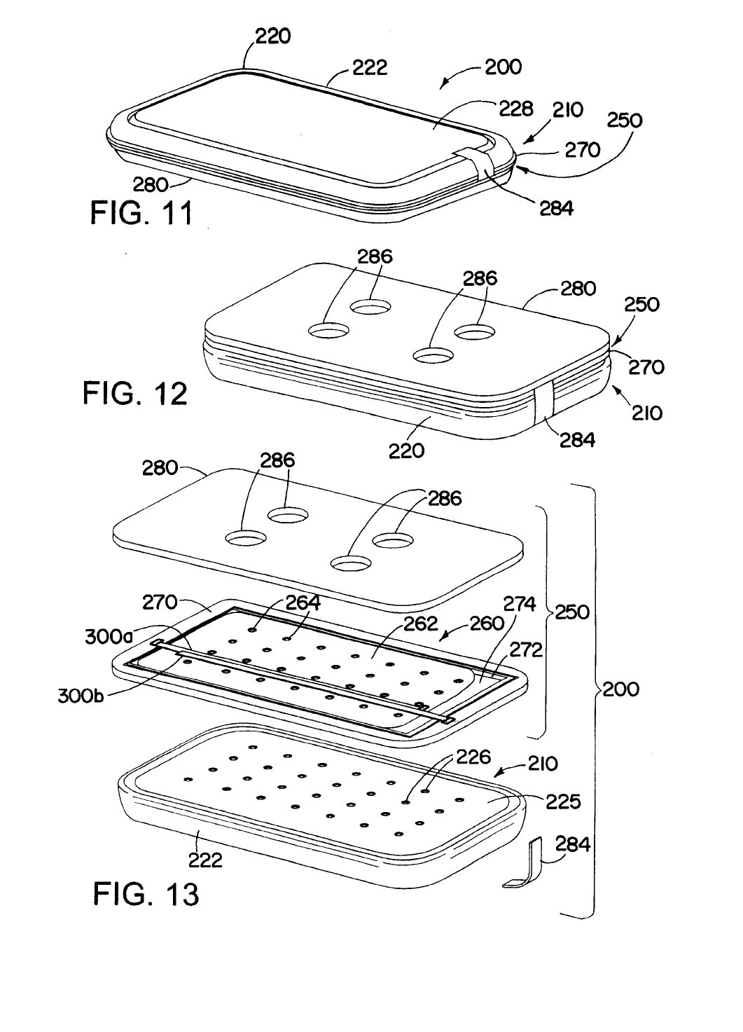

FIGS. 11-13 illustrate an embodiment of a battery 200 comprising a fluid regulating system employing a linear activating system in accordance with the present disclosure. As shown, fluid consuming cell 210 (in this case an air-depolarized cell) includes a cell housing 220, which includes a first housing component and a second housing component, which may include a can 222 and a cover 228, respectively, or may have shapes or sizes different from what would otherwise be considered a can or cover. For purpose of example, the first housing component in this embodiment is referred to as can 222, while the second housing component is referred to as cover 228. Can 222 and cover 228 are both made of an electrically conductive material, but are electrically insulated from one another by means of a gasket (similar to that shown in FIG. 6). Can 222 generally serves as the external positive contact terminal for the fluid consuming cell 210, while cover 228 serves as the external negative contact terminal. Similar to the cell described with respect to FIGS. 4-9, cell 210 further includes a first electrode, which may be the fluid consuming electrode or air electrode, a second electrode, which may be the negative electrode (i.e., the anode), and a separator disposed between the first and second electrodes. In one embodiment, the first electrode is electrically coupled to can 222, while the second electrode is electrically coupled to cover 228.

Can 222 includes a bottom surface 225 in which a plurality of fluid entry ports 226 are provided such that fluid may pass to the interior of cell housing 220 so as to reach the fluid consuming electrode. In the embodiment shown in FIGS. 11-13, a fluid regulating system 250 is secured to the exterior of bottom surface 225 of can 222.

The fluid regulating system 250 according to this particular embodiment may include a valve 260 including a first stationary plate having a plurality of apertures, and a movable second plate 262 including a plurality of apertures 264 that correspond in size, shape, number, and position to apertures formed in the first plate. In this embodiment, the first stationary plate is formed by the bottom surface 225 of can 222 and the apertures are provided by apertures/fluid entry ports 226. It will be appreciated, however, that the first stationary plate may be separate from the can. The size, shape, number, and position of apertures 226 and 264 may be optimized to provide the desired volume and distribution of fluid applied to the fluid consuming electrode. Further, the size, shape, number, and relative location of apertures 226 do not have to be the same as the size, shape, number, and/or relative location of apertures 264. For example, if apertures 226 are slightly different in size from apertures 264, precise alignment of apertures 226 and 264 is not essential to achieve the maximum total open area through the plates.

It may be desirable to provide a separate fixed plate rather than utilizing the surface of the can such that the can bottom will maintain its hole pattern but may act more like an air diffuser rather than an integral part of the valve assembly. Additionally, the separate stationary plate may be spaced apart from the can bottom such that if the can bulges, bows, or possibly wrinkles, it will not disrupt the operation of the valve. It should be noted that the can may be made with a stronger material, a greater thickness, or a different shape (e.g., ridges in the bottom). An additional advantage of utilizing a separate stationary plate is that the valve may be totally preassembled thus providing greater stability of the lubricating fluid layer. This may come, however, at the cost of a thicker battery.

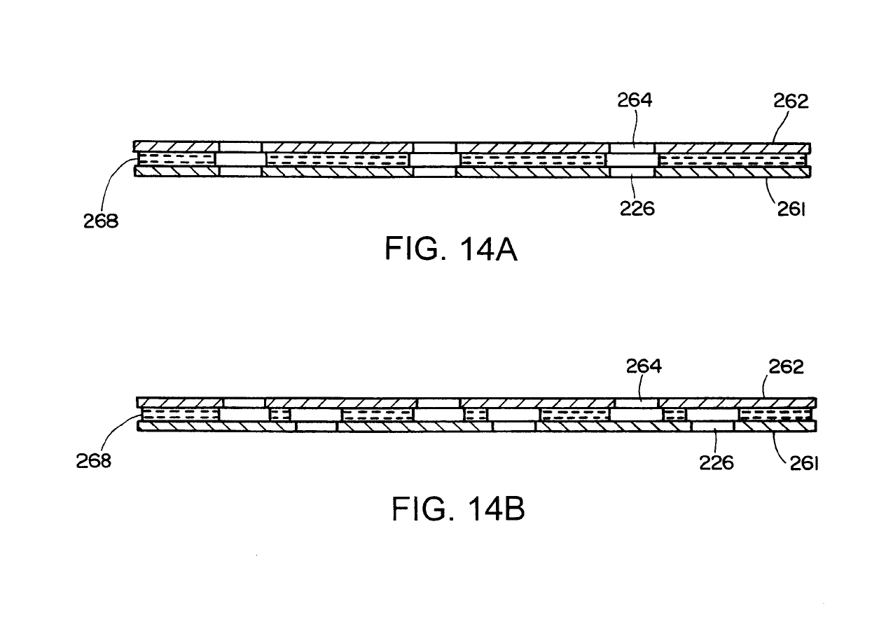

Fluid regulating system 250 may further include a chassis 270 having an annular body portion 272 with an opening 274 in which second plate 262 is disposed. Opening 274 may be shaped and sized to contact the elongated side edges of plate 262 while providing excess space at the shorter side of plate 262 such that plate 262 may be slid linearly along an axis (e.g., in parallel with its length or width). Thus, as shown in FIGS. 14A and 14B, the apertures 264 of second plate 262 may be moved into and out of alignment with apertures 226 of first plate 261 to thereby open and close valve 260. In one embodiment, the chassis may be configured to guide and possibly retain second plate 262 adjacent the first plate 261. As shown in FIGS. 14A and 14B, a lubricating layer 268 may be disposed between plates 261 and 262 to enable second plate 262 to more readily slide along the surface of plate 225. Thus, lubricating layer 268 enables the valve to be opened and closed requiring less force by the actuator. In addition, because it may be difficult to get the surfaces of plates to be sufficiently smooth so as to provide a good seal, the lubricating fluid 268 may be utilized to enhance the sealing characteristic of the valve without requiring complex and expensive machinery of the plates to otherwise further smooth their surfaces. Suitable materials for the lubricating layer include but are not limited to oil, TEFLON®, or the like.

As shown in FIGS. 12 and 13, fluid regulating system 250 may further include a lid or cover 280 that extends over and optionally around chassis 270 to protect and shield fluid regulating system 250. Lid 280 preferably includes one or more holes 286 to allow fluid to pass from the outside to valve 260 for selective passage into cell 210.

In embodiments in which it is powered by the cell, the fluid regulating system can be electrically connected to the cell's positive and negative electrodes. In embodiments in which the fluid regulating system is contained within the cell housing, the electrical connections can also be contained within the cell housing. In embodiments in which the fluid regulating system is located outside the cell housing, a portion of the electrical circuit can also be external, as in the embodiment shown in FIGS. 11-13. Electrical contact between the fluid regulating system 250 and the first (positive air) electrode can be through the bottom surface 225 of the can 222, such as an electrical connection between the can bottom 225 and an electrical contact on the adjacent surface of the chassis 270. Electrical contact between the fluid regulating system 250 and the second (negative) electrode can be through an electrical conductor 284 between an external surface of the cover 228 and the fluid regulating system 250. The end of the electrical conductor 284 connected to the fluid regulating system 250 can be folded or bent to extend into the interface between the lid 280 and the chassis 270 (as shown) or between the can 222 and the chassis. Alternatively, conductor 284 could extend through an opening formed in the lid 280. As discussed below, the electrical contacts to the fluid regulating system can be two a control circuit for controlling operation of the actuators 300a and 300b to open and close the valve 260 in response to a detected cell voltage or current draw.

Electrical conductor 284 may be a tab that includes a foil strip disposed between two insulating layers, which prevent a short circuiting of the cell between the can 222 and cover 228. A first insulating layer may be disposed between the cell housing 220 and the conductive foil. This insulating layer may be made of double-sided tape. The second and outer insulating layer may be disposed over the foil and may comprise a strip of single-sided tape.

Second plate 262 may be made of a magnetic material, such as that commonly used in the gaskets provided on refrigerators. By utilizing a magnetic plate, chassis 270 does not need to be configured so as to include any mechanism for otherwise holding plate 262 firmly against surface 225 of can 222. The magnetic plate 262 may be a flexible magnet that can conform to the shape of adjacent the plate (e.g., bottom surface 225 of can 222). A magnetic plate can be made from suitable magnetic material, such as, for example, a blend of ferromagnetic (e.g., barium/strontium ferrite) and elastomeric materials. A magnetic plate can be a permanent magnet that does not consume energy from the cell to maintain sufficient magnetic force. In one embodiment, moveable second plate 262 can be constrained on the top and bottom by lid 280 and bottom surface 225 of can 222.

Valve 260 may be operated by an actuator, which is part of the fluid regulating system 250. In an embodiment in which a sliding plate valve is operated by an actuator that behaves substantially linearly, the actuator comprises at least one conducting polymer. In one embodiment of a valve operated by a linear actuator, the actuator may be a system comprising a first actuator component comprising a first conducting polymer, and a second actuator component comprising a second conducting polymer; in one embodiment, the first conducting polymer is the same as the second conducting polymer, in one embodiment, the first conducting polymer differs from the second conducting polymer. In one embodiment, at least one of the first or second actuator components comprises polypyrrole, a polypyrrole derivative, or mixtures of two or more thereof.

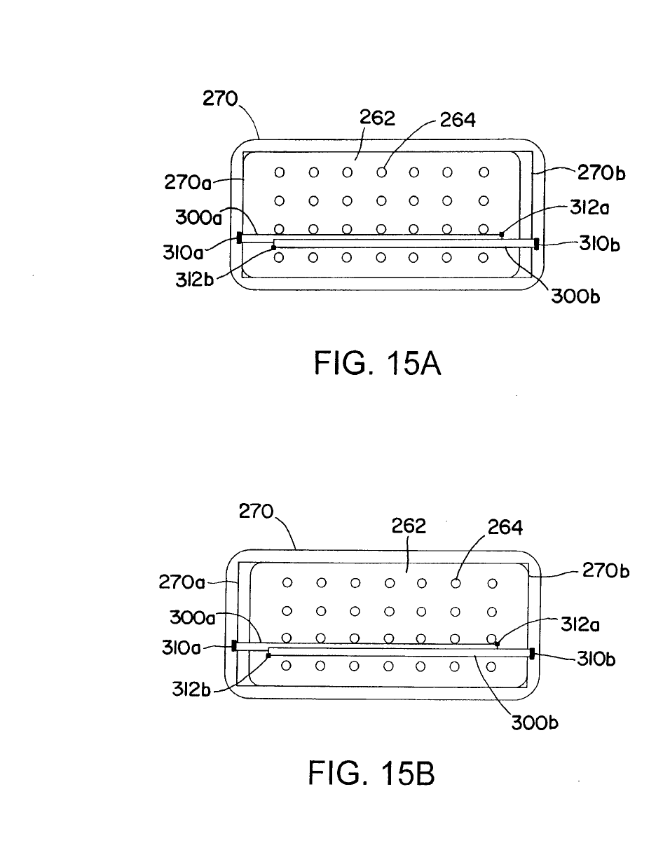

The actuator may have any configuration suitable for causing movement of the valve into an open or closed position. In the embodiment shown in FIGS. 13, 15A and 15B, the actuator includes actuating components 300a and 300b that each comprise at least one conducting polymer. Actuating components 300a and 300b are secured at either end of chassis 270 via attachments 310a and 310b, respectively, and are also anchored to plate 262 via attachments 312a and 312b, respectively. For purposes of discussion, FIG. 15A represents the valve in a closed position and FIG. 15B represents the valve in an opened position. To open the valve, a voltage is applied across actuators 300a and 300b in a manner such that actuator 300b contracts and actuator 300a expands. The contraction of actuator 300b results in plate 262 being pulled or moved away from end 270a of chassis 270 toward end 270b of chassis 270. The valve can be returned to a closed position (e.g., FIG. 15A) by reversing the applied voltage such that actuation is reversed and actuator 300a contracts and actuator 300b expands; the contraction of actuator 300a causes the plate 262 to be pulled or moved away from end 270b of actuator 270 and toward end 270a of chassis 270. It will be appreciated that plate 262 of the valve can be moved to positions intermediate of the positions shown in FIGS. 15A and 15B. That is, the plate and valve can be moved to positions intermediate a fully open or fully closed position. It will be appreciated that more than two actuator components may be provided to operate the valve. Further, it will be appreciated that the actuator component need not be attached directly to the chassis, but could be attached to a spring, clip, etc., that is attached to the chassis, or the actuator component could be attached directly or indirectly to the bottom surface 225 of can 222 (FIG. 12) or to stationary plate 261 (FIGS. 15A and 15B).

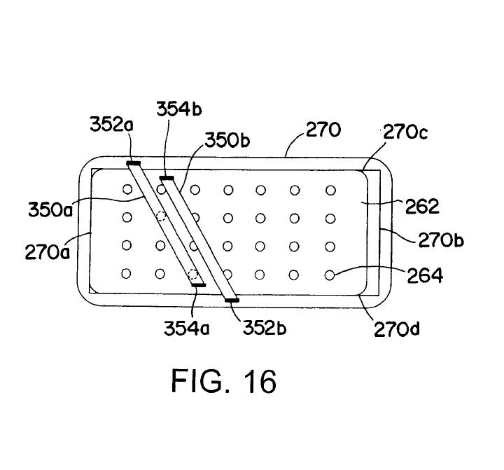

The actuator components need not be disposed generally parallel to the ends of the chassis. In one embodiment (FIG. 16), one or more actuator components 350a could be attached (directly or indirectly) to chassis 270 adjacent side 270c and to a portion of the plate adjacent side 270d of chassis 270, and one or more actuator components 350b may be attached to chassis 270 adjacent side 270d and attached to plate 262 adjacent side 270c of chassis 270. The actuators in this embodiment may be angled relative to the ends 270a and 270b. The actuator components are electrically connected. When a voltage is applied across the actuator, actuator component 350b may be made to contract, which causes the plate to be moved toward end 270b of the chassis. Reversing the potential causes actuator component 350a to contract and move the plate toward end 270a of the chassis.

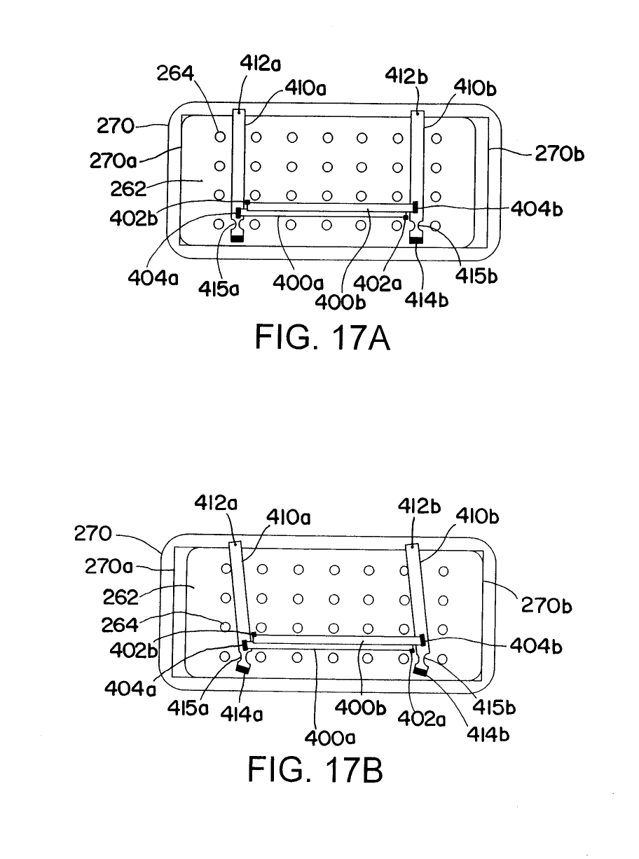

In another embodiment, a valve may be opened or closed using a lever arm mechanism in which one or more lever arms are moved by actuators comprising a conducting polymer. For example, as shown in FIGS. 17A and 17B, lever arms 410a and 410b are attached to plate 262 by attachments 414a and 414b, respectively, and to chassis 270 by pivot pins 412a and 412b, respectively. Lever arms 410a and 410b include a flexure joints 415a and 415b, respectively. An actuator is connected to each lever arm. As shown in FIGS. 17A and 17B, actuator 400a is attached to lever arm 410a via attachment 404a and to plate 262 via attachment 402a, and actuator 400b is attached to lever arm 410b via attachment 404b and to plate 262 via attachment 402b. For purposes of discussion, FIG. 17A represents the valve in a closed position and FIG. 17B represents the vale in an open position. To open the valve, a voltage is applied across actuators 400a and 400b such that actuator 400a contracts and actuator 400b expands, the contraction of actuator 400a causes actuator 400a to pull lever arm 410a, such that lever arms 410a and 410b rotate around the flexure joints and amplifies the motion relative to the chassis and the lever arms rotate about pivot points 412a and 412b, respectively, which results in plate 262 moving towards end 270b of chassis 270. To close the valve, the potential applied across the actuator is reversed such that actuator 400b contracts and actuator 400a expands; the contraction of actuator 400b causes the lever arm 410b to be pulled and lever arms 410a and 410b rotate about pivot points 412a and 412b, respectively, such that plate 262 is moved toward end 270a of chassis 270.

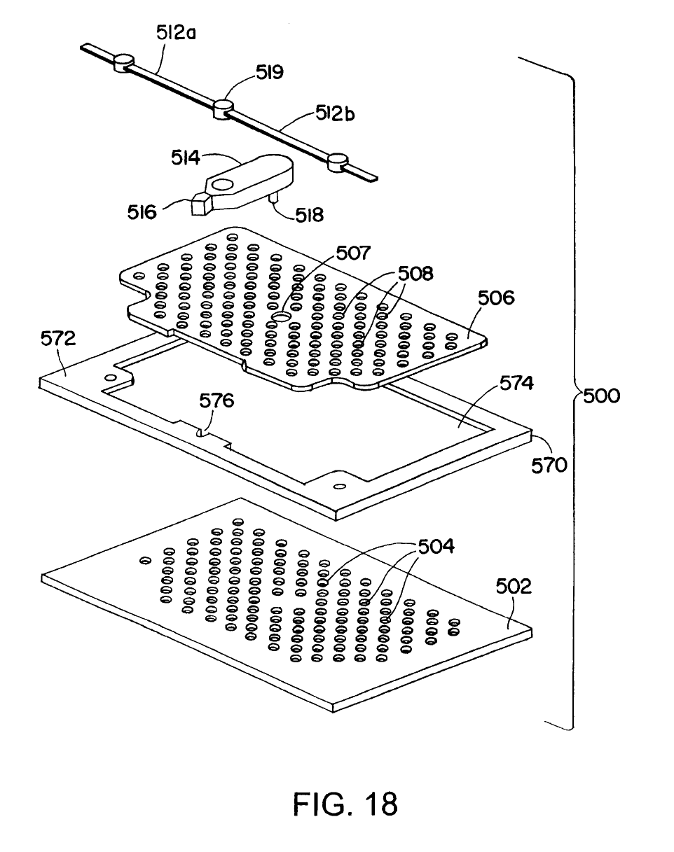

FIG. 18 shows another embodiment of a valve 500 that may be utilized in conjunction with the disclosed technology. Valve 500 includes first plate 502 including a plurality of apertures 504. Plate 502 may be a separate plate that is held stationary relative to chassis 570, may be a portion of the can or cover of a cell housing, or may be a portion of an outer cover plate over the fluid regulating system, for example. Plate 502 may be made of metal, which may be magnetic or non-magnetic. Valve 500 further includes second plate 506 including a plurality of apertures 508 that correspond in number, size, shape, and position to apertures 504 and first plate 502. Plate 506 may be a magnetic or non-magnetic metal. Similar to the embodiments discussed above, a chassis 570, which may be made of an electrically non-conductive material, includes an annular body 572 with a central opening 574 for receiving plate 506. Opening 574 is configured to be slightly larger than plate 506 in one direction so as to enable plate 506 to slide linearly relative to plate 502 such that apertures 504 and 508 may be moved into and out of alignment to open and close valve 500. Lever arm 514 includes a pivot pin 516 that is received in an aperture or a slot or recess 576 formed in chassis 570 such that lever arm 514 may be pivotably secured to chassis 570. This may be done, for example, by enlarging and reshaping the recess 576 to fit around pivot pin 516 and partially extend into the necked area between the pivot pin 516 and the body of lever arm 514 in such a way as to capture pivot pin 516 within the recess 576 but still allow the lever arm 514 to pivot within the recess 576. Other means of securing the pivot pin 516 to the chassis may be used, such as a downward projection from pivot pin 516 that is received in a hole in a ledge at the bottom of the recess 576. A lever arm pin 518 may extend downward from the body of lever arm 514 such that it may be received in a hole 507 formed in second plate 506. This allows lever arm 514 to engage plate 506 and thus to slide second plate 506 relative to first plate 502. In this particular configuration, a pair of actuating components 512a and 512b, is attached via an attachment point 519 to a top surface of lever arm 514. The other ends of actuating components 512a and 512b may be attached to chassis 570. Actuating components 512a and 512b each comprise at least one conducting polymer. Actuating components 512a and 512b can be secured to recesses in the chassis, similar to recess 576, for example. They can be secured in any suitable manner, such as with adhesives, with pins or by fitting enlarged heads into recesses with restricted openings. The actuators may be electrically coupled to a control circuit (not shown in FIG. 18) that selectively applies a current to actuating components 512a and 512b in response to a sensed cell voltage. In this manner, actuating components 512a and 512b may pull the lever arm in either of two opposing directions thus causing lever arm 514 to slide second plate 506 relative to first plate 502. In this case, chassis 570 serves as a mounting location for the pivot point of lever arm 514 and of the ends of actuating components 512a and 512b while also providing a guide for guiding plate 506 relative to plate 502.

As previously described, conducting polymers must be able to exchange ions. Therefore, in embodiments employing linear actuators, the actuator components may be separated by an electrolyte. In one embodiment, the actuator components may be immersed in an electrolyte. In air cells, immersing the actuator components may be accomplished by encapsulating the actuator components in a compartment containing an electrolyte. The material used to encapsulate the actuator components should be essentially impermeable to the electrolyte, should be stable for long periods of time, and should not interfere with the desired movement of the actuator (for example, for an actuator encapsulated by a coating, the coating should be sufficiently flexible to allow to actuator to move).

In one embodiment, the fluid regulating system may be disposed in the interior of the cell housing. In one embodiment, the cell may be slightly thicker to accommodate the fluid regulating system between an air electrode and the inner surface of the can. In such an embodiment, a chassis may also be utilized along with a valve, actuator, and optional control circuit in a manner similar to when the valve is applied to the exterior of the cell. Similarly, the bottom of the can may serve as the stationary plate of the valve and may include a plurality of fluid entry ports. When the valve is disposed on the interior of the cell housing, the sliding plate slides along the inner surface of the can rather than the exterior surface. In such an embodiment, the chassis and hence the valve may be held in place by a gasket.

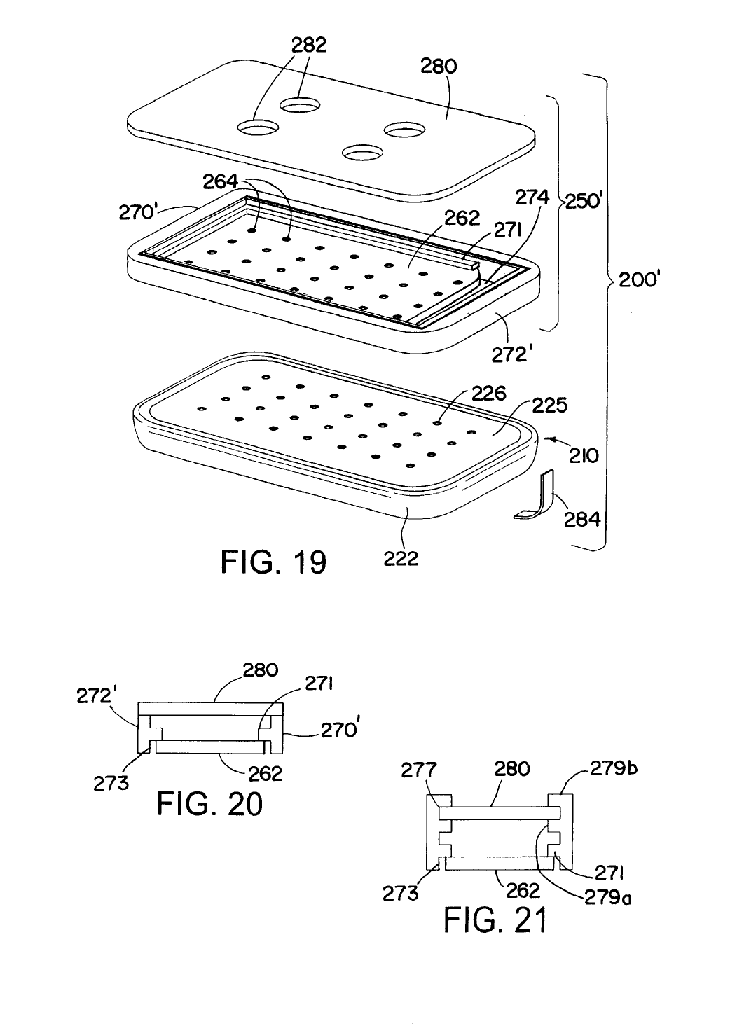

FIGS. 19-21 illustrate an alternative embodiment for the chassis. In FIG. 19, battery 200′ has a fluid regulating system 250′. The chassis 270′ is taller than chassis 270 in FIG. 13. This can facilitate the movement of fluid between the lid 280 and the moveable plate 262, thereby providing more uniform distribution of fluid across the surface of plate 262 and more uniform flow of fluid through apertures 264 and 226 when plates 262 and 225 are aligned in an open position.

Chassis 270′ can include an inward extending ledge 271, creating a race or groove 273 within which plate 262 can slide. The vertical position of ledge 271 can be selected to create a race 273 of the desired dimensions to hold plate 262 firmly enough against surface 225 of can 222 to provide a good seal when plates 262 and surface 225 are aligned in a closed position but not so tightly as to interfere with the desired sliding motion of plate 262 Ledge 271 can be an integral part of chassis 270′, or it can be a separate component. For example, ledge 271 can be in the form of a flat washer or strip insert molded into the chassis body 272′, or it can be a separate component affixed to the chassis body 272′. The ledge 271 can be made of the same material as chassis body 272′ or a different material. Materials for the chassis body 272′ and ledge 271 can be selected to provide both the desired strength and smooth sliding of plate 262 within the race 273 If either the chassis body 272′ or ledge 271 is made from an electrically conductive material, insulation from the electrical components of the actuator system and/or any control circuit may be required. As an alternative to a continuous ledge, a series of projections can be used.

The ledge 271 and/or chassis body 272′ can also be modified to incorporate one or more additional structures, such as ribs extending across the opening 274′ above plate 262, to hold the central portion of plate 262 flat. Alternatively, downward projections from the lid 280 can be used to hold the central portion of plate 262 flat.

The chassis 270′ can include a second race 277 in which the lid 280 is held, as shown in FIG. 21. This second race can be formed by one or more additional ledges 279a and 279b. This arrangement can facilitate pre-assembly of the lid and components of the fluid regulating system, to be added to the fluid consuming cell at another step in the manufacturing process. In another embodiment in which the stationary plate is not a surface 225 of the can 222, the chassis 270′ can include another ledge (not shown) below ledge 271, forming a larger race that retains the stationary plate as well as movable plate 262.

The ledge 271 of chassis 270′ can be a continuous ledge extending around the entire perimeter of opening 274′, or it can be a discontinuous ledge extending along only part of the perimeter, as shown in FIG. 19. If the discontinuous ledge is suitably located and the moving plate 262 is sufficiently flexible, if the pressure within the cell becomes excessive, the edge of the moving plate 262 can bow outward between the ends of the discontinuous ledge 271 to provide a passageway between the plate 262 and both the stationary plate (e.g., surface 225) and chassis frame 272′ through which gases can escape to the external environment when the valve is partially open or closed. In such embodiments the plate 262 may have spring-like properties so that when the internal cell pressure is sufficiently reduced the plate 262 will again conform to the shape of the surface 225 of the can 222.

In an alternative embodiment in which the lid serves as the stationary valve plate and the moveable plate is disposed adjacent to the lid, the chassis can include a ledge to hold the moveable plate against the lid while maintaining a space between the moveable plate and the surface of the can bottom, to facilitate uniform air distribution to the apertures in the can. As described above, this embodiment can also include a second race in the chassis in which the lid is held.

A fluid regulating system comprising a sliding plate valve may be secured to the exterior of cell using a variety of techniques. In one embodiment, the lid may be configured to have a plurality of stand-offs that extend downward from an inner surface of the lid and then pass through holes in corresponding locations on the chassis such that the stand-offs may be attached to the bottom of the can. In one embodiment, the lid may be formed of plastic, and the stand-offs may be ultrasonically welded to the bottom surface of the can. In this case, there would be no electrical connection between the lid and the can. In another embodiment, the stand-offs may be provided as an indentation/protrusion in a metal lid which may be formed by stamping or the like, and the metal lid may be resistance- or laser-welded to the bottom surface of the can.

In an alternative method of connecting the chassis and the lid to the exterior of the cell, vias may be provided through holes of the chassis that serve to weld the lid to the can. This weld also provides an electrical connection between the lid and the cell.

In one embodiment, a metal lid may be secured to a can using a conductive epoxy that is provided in holes of the chassis. As yet another alternative, the fluid regulating system may be secured to the bottom surface of the can using an adhesive, a combination of an adhesive and a label, by means of a press fit of the chassis into one or more grooves coined in the bottom surface of the can, by such a press fit of the chassis in addition to utilizing an adhesive, by crimping the can within a second can where the second outermost can replaces the lid, by soldering or welding a laminar chassis, or encapsulating the fluid regulating system in an epoxy.

The fluid regulating system, whether employing a bending actuator or a linear actuator, will be electrically connected to at least the positive electrode of the cell in order for the cell potential to be applied across the fluid regulating system. Generally, in the fluid regulating system, the actuator may be viewed as a 2-electrode actuator. For example, in a bending/flap actuator such as actuator 50, layers 52 and 54 (comprising an ionic polymer) each serve as an electrode and are essentially counter electrodes to each other. Similarly, the actuator components in the linear actuator systems serve as counter electrodes. One electrode will be electrically connected to the positive terminal of the cell and the other electrode will be electrically connected to the negative terminal of the cell.

Electrical connections between the actuator and the cell electrodes can be accomplished in any suitable manner that provides a reliable connection and does not result in a completed electrical path (e.g., an internal short circuit) between the cell positive and negative electrodes.

For example, one electrode portion of the actuator can be in direct physical and electrical contact with the oxygen reduction electrode, which is, or is electrically connected to, the positive terminal of the cell. In another example, an electrode portion of the actuator can be in direct contact with an electrically conductive portion of the cell housing that is in electrical contact with the positive electrode. In yet another example, an electrical lead can be used to provide electrical contact with the positive electrode.

The electrode portion of the actuator that is electrically connected to the negative electrode of the cell can be connected with an electrical lead. The electrical lead can go around or through the oxygen reduction electrode and/or the positive electrode, as long as the lead is electrically insulated therefrom.

For example, the lead connecting the electrode portion of the actuators to the negative electrode of the cell may be in the form or a wire or thin metal strip, with a dielectric material coating any parts of the lead that may otherwise come in electrical contact with the positive electrode (either directly or through another cell component, such as a conductive portion of the cell housing, a positive electrode current collector or a positive electrode electrical contact lead or spring). In another example the electrical lead to the negative electrode may be in the form of one or more thin layers of metal printed or otherwise deposited on a portion of one or more other cell components, such as surfaces of gaskets, insulators, cans, covers and the like. Layers of a dielectric material may be coated over and/or beneath the metal layers to provide the necessary insulation from the positive electrode.

The fluid regulating system may be operated by the cell or battery voltage itself, electronic controls based in part on the cell or battery voltage, and/or by employing a scaling circuit. The manner in which the valve is operated may be selected based on various factors including, the voltage range or step in the battery over which the valve is to be operated, the strain of the actuator for a particular voltage step, the maximum frictional force that must be overcome to operate the valve such as, for example, the force to separate a flap valve from a sealing layer or the force to slide one plate relative to another in a sliding plate valve, the minimum displacement required for the valve, and/or the size of the battery including the available head space. In particular, the minimum volume of conducting polymer required for a linear actuator is a function of the maximum frictional force required to operate the valve, a conducting polymer's strain over a given voltage drop, and the desired displacement of the valve. Generally, the strain of a conducting polymer is greater over larger changes in voltage. Therefore, the larger the voltage drop in the cell, the less volume of conducting polymer will be required to operate the valve. Thus, the volume of conducting polymer employed may be reduced by utilizing a scaling circuit to scale the voltage and create a large voltage change, which increases the polymer's strain.

The potential applied to the actuator to operate the valve of the air regulating system can originate within the cell. For example, the potential applied to the actuator can be the cell potential, as described above. The cell potential can also be changed. If a higher voltage is needed to produce a sufficient actuator dimensional change, the cell potential can be adjusted upward. Adjusting the cell potential can allow the use of different types of materials for the actuator. Increasing the cell potential can be accomplished, for example, with a control circuit, to step up the cell voltage and induce deformation of the actuator to operate the valve.

A control circuit can be used in other ways to monitor the need for oxygen and then apply a potential across the actuator to open or close the valve. For example, the control circuit can include an oxygen sensor to monitor the oxygen level in the cell, it can be used to monitor the cell voltage, and it can be used to monitor the potential of the oxygen reduction electrode against a separate reference electrode. The potential applied across the actuator can originate within the cell (e.g., the potential between the positive and negative electrodes) and be adjusted upward or downward if desired, or the potential can originate outside the cell (e.g., another cell in the battery or other suitable power source). The control circuit can be printed or otherwise applied to a cell or battery component, it can be included in an electronics chip, or any other suitable arrangement can be used.

In one embodiment, a control circuit may be an application specific integrated circuit (ASIC), which may be mounted on a surface of a chassis (e.g., chassis 270). The body of the chassis may be made of a non-conductive material such that electrically conductive tracings may be printed on a surface of the chassis as further discussed below. Thus, in one embodiment, the chassis may thus be a printed circuit board (PCB). The chassis could be molded or shaped and most or all of the electrical connections could be pressure contacts to minimize the sophistication of assembly. The chassis may, however, require some machining and some electrical connections and may require some soldering or welding. The selection of the chassis material may be based on its compatibility with its multi-functional use as a frame to house the valve, as a printed circuit board for the electronics, and for its ability/compatibility to be attached to the cell. A strategic depression may be provided in and/or on a laminar structure of the chassis for mounting the control circuit. This would allow any mounted parts to be maintained flush with the surface of the chassis to facilitate assembly with the cell. It is also possible that it may become desirable to coat the printed circuit tracings with a nonconductive material to prevent shorting if pressed against a metal lid or can. Alternatively, one or more recesses may be provided in the chassis, such as by molding or machining, to accommodate all or a portion of one or more components of the control circuit and the actuator. These recesses can be useful to allow positioning of components in different locations on the chassis and anchoring of components that extend beyond the chassis frame, as described below.

As a platform for the electronics, it would be desirable for the base material of the chassis to be an existing PCB material. The most common base materials contain epoxy resins and fiberglass reinforcement. It may be desirable for the chassis to be of laminar construction to integrate and protect the electronic circuit components, as well as to maintain a flush surface, parallel with the bottom surface of the can. As described above, the inside diameter of the chassis may utilize a metal race for durability to house a sliding valve plate. The race may “lock” such a plate in place (so it does not fall out), provide enough axial force to prevent the valve plates from separating during use but insufficient force to prevent a moveable plate from sliding. The chassis may thus be formed, molded, or machined, dependent on the material selection, so as to achieve the valve race shape, whether metal or not, to flush mount a chip and to generate vias (through-holes). There may be conductive circuitry within the vias—on one side and an edge of a chassis if mounted external to the cell, or on both sides of the chassis if mounted internal to the cell.

A conductive pathway for a control circuit may be provided on both sides of the chassis and within the vias. This may be accomplished by a plating process or screen printing a conductive paste, especially to fill the vias. Conductive foil could be applied to the substrate at formation and the unwanted portion etched away. Copper is the most common material used. It may require multiple layers and multiple materials to assure adherence to the substrate depending on the base material utilized.

One method of attaching an ASIC serving as a control circuit is to use a direct method, as opposed to a packaged chip, due to volume constraints. Common methods of direct chip attachment include wire bonding and flip chip. Wire bonding may use wires about 0.02 mm (0.0008 inch) in diameter that are bonded to the four to six chip pads and the circuit substrate. The chip and wire bonds may be encapsulated in non-conductive epoxy for protection. With a flip chip attachment, the pads may be pre-finished with a Pb/Sn solder and, in turn, soldered to the substrate. Once attached, the chip may be encapsulated with non-conductive epoxy to provide protection.

Instead of incorporating the control circuit electronics within the fluid regulating system, they can be located externally. This may be desirable in situations where they cannot be conveniently fit internally, for example. In one embodiment the electronics can be mounted on an exterior side of the fluid regulating system, such as within a cap mounted on the side wall of the fluid regulating system and/or the cell. The actuator components may be connected directly to the contact terminals with no intermediate control circuit, and a control circuit may be contained in a circuit board secured to the side of the chassis with a cap that protects the circuit board. The contact terminals on the chassis make electrical contact with corresponding terminals on the surface of the circuit board. Electrical contact can be made in any suitable manner, such as by pressure contact. The circuit board can have a single substrate layer, or it can be a laminated substrate with two or more layers. The electronics components and electrical connections can include printed or non-printed components, or combinations thereof. Larger components can be disposed in recesses in the surfaces of the circuit board to provide flush fits with the chassis and the cap. The electrical connections between the circuit board and the cell are not shown, but these connections could also be made through the chassis.

As described above, the fluid regulating system can use electronic controls to operate the valve, based in part on the cell (or battery) voltage. However, a switch can be used to close an electrical circuit through an actuator that changes length to move the valve to an open or a closed position, with the circuit subsequently being broken to stop the flow of current through the actuator when the valve reaches the full open or closed position. This can eliminate the need for more complex control circuits, while still drawing energy from the cell only when needed to open or close the valve. The switch can be on or within the battery itself, or it can be a part of the device in which the battery is used. In one embodiment, the device on/off switch also alternately closes the circuits through opposing actuators to open and close the valve.

Contact terminals may be provided on the chassis for connection to the positive and negative terminals of the cell. The contact terminals may be provided on any surface of the chassis. In one embodiment, one of the contact terminals may be provided on an outer facing edge surface of the chassis such that it may be exposed to the outside of the battery assembly for subsequent connection to the cover of the cell. In such an embodiment, the other contact terminal may best be provided on an inner surface that is either pressed into electrical contact with a conductive portion of the lid or on the opposite surface in electrical connection with the bottom surface of the can.

In one embodiment, a valve is in an open condition when a current is applied indicating that the cell is in use, and is closed when a current is not applied indicating that the cell is not in use. In general, when the current applied to the actuator is provided from the cell it can be advantageous for current to be applied only to initiate movement of the actuator and not while the actuator is in a static condition in order to prevent unnecessary use of cell capacity.

Another consideration relates to the initial activation of the battery. The battery may be built with the valve in the open position and with the holes of a cover protected by a tab similar to conventional button air cells. Removal of the tab would activate the cell, initiate electronic control of the valve, and maximize the shelf life of the battery. Alternatively, the battery could be built with a functioning fluid regulating system. This would allow the battery to be immediately useable by the consumer but may also require suitable packaging and storage conditions in the warehouse, store shelves, etc. to prevent moisture ingress in humid environments and moisture egress in dry environments.

Although not illustrated in the drawing figures, a label may be provided to the outer surface of the cell housing. Such a label may extend around the perimeter of the cell so as to further cover an electrical conductor tab (discussed above) as well as the interfaces between the fluid regulating system and the cell and to cover the interface between the can and the cover. Sufficient portions of the cover and the can and/or a conductive lid could remain exposed to provide electrical contact terminals on the outside of the battery.

The particular cell construction illustrated in the various embodiments is a prismatic cell design having a generally rectangular shape. In one embodiment, a prismatic cell may have a generally square shape or otherwise can be non-cylinder in shape. Cells in accordance with the disclosed technology are not limited to prismatic designs, and may also be, but are not limited to, flat cells having a generally non-cylindrical shape, or button-type cells having a generally cylindrical shape. It should be appreciated by those skilled in the art, however, that the cell need not have the particular shape, size, or relative dimensions as that shown in the drawings. The materials suitable for particular cell components such as the air electrodes, anodes, separators, can, and/or cover are generally known or ascertainable by those skilled in the art.

In an embodiment in which the actuator forms the valve, such as in the flap-valve design shown in the embodiments of FIGS. 4-10, the actuator may comprise at least one conducting polymer. In another embodiment, a flap-valve actuator may comprise at least one ionic polymer-metal composite. In embodiments in which a valve comprises a linear actuator, such as, for example, the embodiments shown in FIGS. 13 and 15-18, the actuator may comprise at least one conducting polymer. Generally, ionic polymer-metal composites are difficult to actuate linearly.

Ionic polymer-metal composites typically include, a polymer layer disposed between two metal layers that behave as electrodes. The polymer may generally be an ion exchange membrane through which the ion may migrate. The cations may include, but are not limited to, potassium, sodium, ionic liquid cations, and the like. Suitable materials for the metal layers include, but are not limited to, platinum, gold, copper, conducting polymers and other relatively inert conductive materials, and the like. It is desirable for the metal layers in an ionic polymer-metal composite to have a relatively high surface area in contact with the electrolyte.

Conducting polymers suitable for use in either a bending or linear actuator include, but are not limited to, polyphenylene, polyphenylenevinylene, polyphenylenesulfide, polyfluorene, poly(p-pyridine), poly(p-pyridalvinylene), polypyrrole, polyaniline, polythiophene, polythiophenevinylene, polyfuran, polyacetylene, and/or substituted versions/derivatives of such polymers.

Polyphenylene, polyphenylenevinylene, and polyphenylenesulfide (and the monomers and oligomers of the monomers of these polymers) may include substituents chosen from groups such as a hydrogen atom or a nonconjugated substituent, such as, for example, hydrocarbyls, substituted hydrocarbyls, hydrocarbyloxys, poly(oxyalkylene)s or mixtures of two or more thereof. The substituents may be straight chained or branched. Hydrocarbyls include, but are not limited to, alkyls, alkenyls, aryls, cycloalkyls, and the like. Substituted hydrocarbyls may include substituents chosen from the groups such as, but not limited to, hydroxy, acyl, acylamino, acyloxy, alkoxy, alkenyl, alkynyl, amino, aminoacyl, aryl, aryloxy, carboxy, carboxyalkyl, cyano, cycloalkyl, guanidino, halo, heteroaryl, heterocyclic, nitro, thiol, thioaryloxy, thioheteroaryloxy, and the like. Hydrocarbyloxys include, but are not limited to, alkoxys, alkoxyalkyls, and aryloxys.

Poly(oxyalkylene) refers to a polyether that may have from about 2 to about 100 oxyalkylene units; the alkylene portion may be any alkylene including, for example, typically a 2 or 3 ethylene, propylene, or the like. Alkoxy refers to the group alkyl-O—, and may include, for example, methoxy, ethoxy, n-propoxy, iso-propoxy, n-butoxy, tert-butoxy, sec-butoxy, n-pentoxy, n-hexoxy, 1,2-dimethylbutoxy, and the like. Alkoxyalkyl refers to the group -alkylene-O-alkyl, and may include, for example, methoxymethyl (CH₃—OCH₂—), methoxyethyl (CH₃—O—CH₂—CH₂—) and the like. Alkenyl refers to groups having at least 1 site of alkenyl unsaturation, including, for example, ethenyl (—CH═CH₂), n-propenyl (i.e., allyl) (—CH₂—CH═CH₂), iso-propenyl (—C(CH₃)═CH₂), and the like. Suitable alkyl groups include, but are not limited to, methyl, ethyl, n-propyl, iso-propyl, n-butyl, iso-butyl, n-hexyl, and the like. Aryl groups include aromatic carbocyclic group of from 6 to 14 carbon atoms having a single ring (e.g., phenyl) or multiple condensed rings (e.g., naphthyl or anthryl). Aryloxy refers to the group aryl-O—.

Cycloalkyls include cyclic alkyl groups or cyclic alkyl rings of at least 3 carbon atoms having a single cyclic ring or multiple condensed rings. Examples of cycloalkyl groups include, but are not limited to, single ring structures such as cyclopropyl, cyclobutyl, cyclopentyl, cyclooctyl, 1-methylcyclopropyl, 2-methylcyclopentyl, 2-methylcyclooctyl, and the like, or multiple ring structures such as adamantanyl, and the like. Examples of suitable cycloalkyl rings include single ring structures such as cyclopentane, cyclohexane, cycloheptane, cyclooctane, and the like, or multiple ring structures.

In one embodiment, conducting polymers such as polyfluorene, poly(p-pyridine), and poly(p-pyridalvinylene) (and the monomer and oligomers of the monomer of these polymer) may include substituents chosen from, but not limited to, a hydrogen atom, groups such as, for example, alkyl, alkenyl, alkoxy, cycloalkyl, cycloalkenyl, alkanoyl, alkylthio, aryloxy, hydroxy, acyl, acylamino, acyloxy, alkoxy, alkenyl, alkynyl, amino, aminoacyl, aryl, aryloxy, carboxy, carboxyalkyl, cyano, cycloalkyl, guanidino, halo, heteroaryl, heterocyclic, nitro, thiol, thioaryloxy, thioheteroaryloxy, cycloalkyl, or mixtures of two or more thereof.

In one embodiment, polyaniline, polypyrrole, polythiophene, polythiophenevinylene, and/or polyfuran (and the monomer and oligomers of the monomer of these polymer) may include substituents chosen from a hydrogen atom, groups such as, for example, alkyl, alkenyl, alkoxy, cycloalkyl, cycloalkenyl, alkanoyl, alkylthio, aryloxy, alkylthioalkyl, alkylaryl, arylalkyl, alkylsulfinyl, alkoxyalkyl, alkylsulfonyl, aryl, arylthio, arylsulfinyl, alkoxycarbonyl, arylsulfonyl, carboxylic acid, halogen, cyano, or alkyl substituted with one or more of a sulfonic acid, carboxylic acid, halogen, nitro, cyano, or epoxy moieties, or mixtures of two or more thereof.

Optionally, a conducting polymer may include a dopant anion incorporated in the polymer backbone. Examples of suitable dopant anions include, but are not limited to, tetrafluoroborate, trifluoromethenesulfonate, hexafluorophosphate, dodecylbenzene sulfuroic acid, nitrate, methylsulfonate, or mixtures of two or more thereof. In one embodiment, a conducting polymer comprises a hexafluorophosphate anion.

Any suitable electrolyte may be used to actuate the actuators. Suitable electrolytes include, but are not limited to, sodium chloride, sodium acetate, sodium hexafluorophosphate, 1-butyl-3-methyl imidazolium tetrafluoroborate, at least one phosphonium based ionic liquid, at least one imidazolium based ionic liquid, or mixtures of two or more thereof. In an embodiment in which an actuator comprises a conducting polymer that has been doped, the anion from the electrolyte may be (i) the same as the dopant anion, or (ii) different from the dopant anion.

Bending/flap actuators may be made by several different methods. In one embodiment, a bending actuator may be formed electrochemically by providing a separator, depositing a thin layer of an electrically conductive material on opposite sides of the separator and then depositing the conducting polymers over the electrically conductive material such as by electrochemical deposition. Suitable deposition electrodes include, but are not limited to glassy carbon, platinum, gold, titanium, and the like. In one embodiment, a conducting polymer layer may be deposited on a separator by electroless deposition. Bending/flap actuators formed from two or more bilayers may be formed by (i) forming a polymer layer (e.g., a conducting polymer layer) on a backing material, and (ii) sandwiching a separator between two polymer layers. The backing material may be conductive or non-conductive. The use of conductive backing materials allow the conducting polymer to be applied to the backing by electrodeposition. An outer insulating layer may be required with conductive backing materials. An attachment means, such as an adhesive, may be required to secure a conducting polymer film to a non-conductive backing material. Suitable backing materials for a polymer layer include, but are not limited to, gold, glassy carbon, platinum, metal coated polymers (when the conducting polymer is electrodeposited), and polymers (when the conducting polymer is electrolessly deposited). Suitable non-conducting backing materials include silicone, mylar tape, plastics, and the like.

The separator in bending/flap actuators may be chosen from any suitable ion permeable material. Examples of materials suitable for the separator include, but are not limited to polyvinylidene fluoride (PVDF) membranes, fluorinated sulfonic acid copolymer membranes (e.g., NAFION® membranes, E. I. du Pont de Nemours and Company, Wilmington, Del., USA), perfluorocarboxylic membranes, sulfonated poly(arylene ether sulfone), sulfonated poly(thioether sulfone), suflonated poly(ether), sulfonated poly(ether ketone), sulfonated polysterine, sulfonated polybutediene, and the like.

Bending/flap actuators may be saturated with an electrolyte, which is accomplished by soaking, wicking, or the like. As such, bending/flap actuators need not be immersed in an electrolyte solution during operation

In one embodiment, a bending/flap actuator may be encapsulated to prevent the actuator from drying out or at least delay or slow the period of time it takes the actuator to dry out. A bending/flap actuator may comprise a sealing or encapsulation layer disposed about the outer layers comprising an ionic polymer such as a conducting polymer. The sealing or encapsulation layer may be formed from any suitable coating, including, for example, a silicon coating or parylene. The encapsulation layer should generally not be flexible so the actuator may still be able to suitably bend or flap during actuation. The encapsulation layer(s) should be thin enough such that the actuator is still able to bend or flap. In one embodiment, the encapsulation layer(s) may be from about 0.1 to about 10 μm thick. The encapsulation layer may be formed by any suitable coating method including spraying, brushing, dipping, or the like.

In bending/flap actuator formed from bilayers stacked and separated by a separator, the actuator may be sealed with a coating as described above. Alternatively, an actuator formed from stacked bilayers may be encapsulated by providing stacked bilayers having backing layers that extend beyond the ionic polymer layers. The overhanging edges of the backing layers may be sealed together to encapsulate the conducting layers and the separator.

Linear actuators may be formed by, for example, depositing a layer comprising at least one conducting polymer on a substrate and then later detaching the conducting polymer layer from the substrate to provide a conductive polymer sheet or film. In another embodiment, a linear actuator may be formed by growing a conducting polymer onto a supportive scaffold so that the conducting polymer position is constricted and expansion or contraction of the conducting polymer moves the scaffold. For example, a metal wire (e.g., a gold wire) may be provided in a zig-zag or ladder configuration and a conducting polymer may be grown around the wire.

Conducting polymers may undergo an irreversible contraction upon initial temperature exposure. In one embodiment, a conducting polymer film or actuator comprising a conducting polymer film may be pre-shrunk by soaking in electrolyte. The soak time may vary depending on the conducting polymer being utilized. In one embodiment, for example, polypyrrole may be pre-shrunk in electrolyte for around 10 hours at room temperature. The soak time may be reduced by increasing the temperature.

Conducting polymers and actuators formed from conducting polymers may be made by any method suitable for a given conducting polymer, which may be readily ascertainable by a person skilled in the art. Different synthesis conditions may provide a conducting polymer with different properties, and the method may be selected based on the properties desired for a particular application or use. For example, conducting polymers comprising polypyrrole may be made by various methods including, but not limited to, those described in Gel-like Polypyrrole Based Artificial Muscles with Extremely Large Strain, Polymer Journal, 36 (2004) 933-936, Enhanced of Electrical Conductivity of Polypyrrole Film by Stretching: Counter Ion Effect, Synthetic Metals, 26 (1988) 209-224, and The Effect of Ph on Polymerization and Volume Changes in PPy(DBS), Electrochimica Acta, 44 (1998) 219-238, the disclosures of which are incorporated herein by reference. The synthesis of various polypyrrole films and various properties thereof are also described in a Masters Thesis authored by one of the named inventors and titled “Feasibility of Miniature Polypyrrole Actuated Valves”, which is scheduled to be published on Apr. 23, 2007 and will be available at the University of British Columbia library, Vancouver, British Columbia, Canada.

Although the disclosed technology has been described above with respect to single batteries having a single cell, aspects of the disclosed technology may apply to batteries having multiple cells, and battery packs having multiple batteries. For example, the fluid regulating system may be completely or partially disposed in a housing of a battery pack so as to selectively open and close a valve that allows air or another fluid to pass into the battery pack housing. In this case, separate fluid regulating systems would not be needed for each battery. Further, the fluid regulating system could be powered from any one or group of the batteries or all of the batteries within the battery pack or from another battery outside the battery pack.

The fluid regulating system may also be disposed completely or partially within a device that is powered by the battery, batteries, or battery pack or otherwise provided separate from the battery, batteries, or battery pack. For example, the valve could be a pre-packaged module that serves a variety of multi-cell pack sizes. So there may be advantages to packaging the valve, valve power supply and controls separately from the fluid consuming cells.

The combination of a fluid consuming battery and a fluid regulating system can include a module containing all or a portion of the fluid regulating system into which one or more replaceable fluid consuming batteries are inserted. This allows reuse of at least part of the fluid regulating system, thereby reducing the cost per battery to the user. The module can include one or more fluid inlets and can also include internal channels, plenums or other internal spaces that provide a passageway for fluid to reach the battery. The module and battery can be held together in any suitable manner, including the use of electrical contacts that are part of the module that cooperate with the corresponding electrical contacts that are part of the battery to prevent inadvertent separation of the module and battery. For example, the electrical contacts on the module can be in the form of projecting blades that snap into slots in the battery case that contain the battery electrical contacts. The blades can be held in the slots by any suitable means, such as by interference fit, one or more springs, a mechanical locking mechanism and various combinations thereof. The module and battery dimensions, shapes and electrical contacts can be configured to allow mating of the module and battery in only the proper orientations in order to assure proper electrical contact and prevent battery reversal. The module, the battery or both can have external contact terminals for making proper electrical contact with a device in which the combined battery and module are installed. In some embodiments the battery can be replaced without removing the module from the device.

The disclosed technology may be further understood with reference to the following Examples. The Examples merely illustrate exemplary embodiments of the disclosed technology and are not intended to limit the disclosed technology to such specific embodiments.

### EXAMPLE 1

### Bending/Flap Actuator

A bending/flap actuator was prepared by as follows. A trilayer was prepared by evaporating 70 nm of platinum onto opposing surfaces of a 110 μm PVDF Millipore separator. A 30 μm layer of polypyrrole was then deposited over each platinum layer. The polypyrrole layer was a polypyrrole film doped with hexafluorophosphate (PF₆⁻) ions. The polypyrrole film was deposited onto the platinum surfaces using a solution comprising 0.06M distilled pyrrole, 0.05M tetrabutylammonium hexafluorophosphate and 1% water by volume in polycarbonate. Deposition was performed galvanostatically at 0.125 mA/cm² for a time sufficient to produce a 30 μm layer.

The actuator was actuated in an aqueous solution of sodium hexafluorophosphate (NaPF₆). The voltage was stepped between 1.4 V and −1.4 V. The actuator exhibited a bending or flapping motion in response to the voltage.

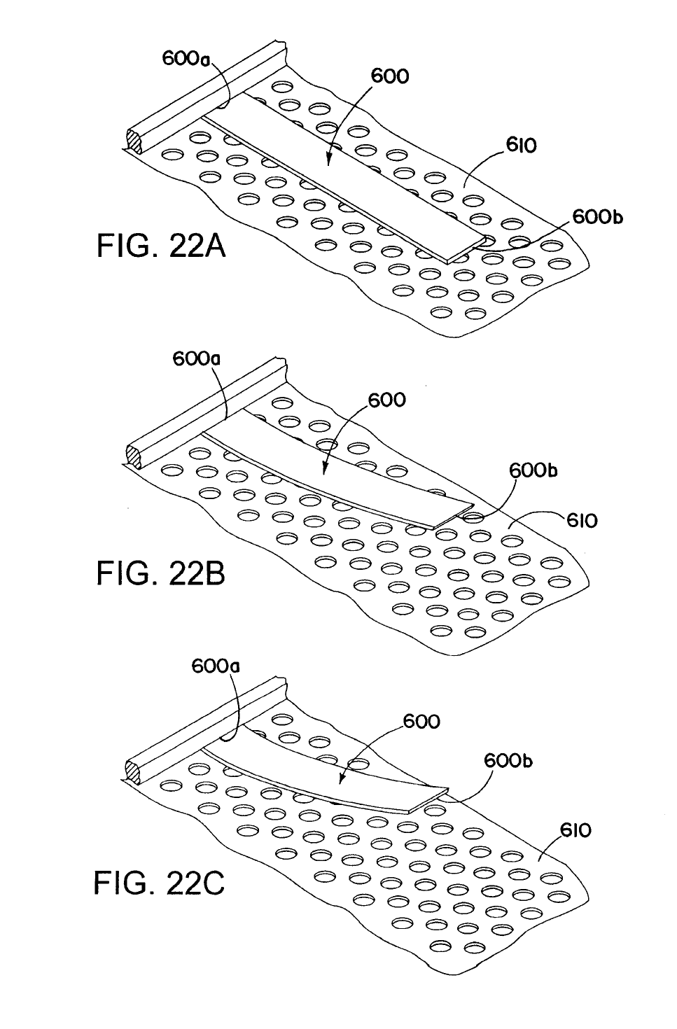

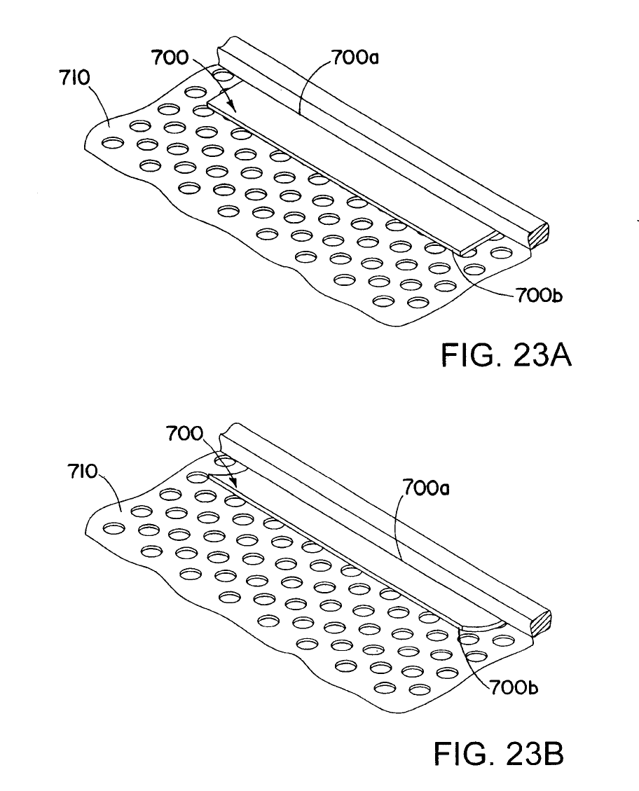

Actuators in accordance with this example were also tested for their operation as a valve. Actuator strips as described above were placed over a metal plate comprising a number of holes such that the actuator strip partially covered a series of holes on the plate. The dimensions of the actuator were 5 mm by 30 mm. A layer of oil was placed between the actuator strip and the plate. Two tests were run. In one test (FIGS. 22A, 22B and 22C), one width wise (short) edge 600a of the actuator 600 was anchored to the plate 610 so that the opposite width wise edge 600b of the actuator was displaced from the plate (i.e., the actuator contracts along its length). In the second test (FIGS. 23A and 23B), the actuator 700 was anchored to the plate 710 along one length wise edge 700a so that the opposing length wise edge 700b would be displaced from the plate (i.e., the actuator contracts along its width). The voltage was stepped between 0 V and 1 V. In FIGS. 22A and 23A the actuators 600 and 700 are against the plates, sealing the holes. In FIGS. 22B and 23B, edges 600b and 700b of the respective actuators have separated from the oil layers and lifted off the plates to at least partially open the previously sealed holes. In FIG. 22C edge 600b of the actuator is raised higher than in FIG. 22B to further expose holes in the plate.

### EXAMPLE 2

### Encapsulated Bending/Flap Actuators

Two actuator strips were prepared as described in Example 1. The actuators were dried in air for two weeks. The ends of the actuator were compressed between two glass slides and then sprayed on both sides with a coating material. One actuator was sprayed with a silicone coating, Silicone Conformal Coating 422A (MG Chemicals), and the other actuator was sprayed with an acrylic coating, Acryl Conformal Coating 422A (MG Chemicals), to create a 2-8 μm thick coating on the outer surface of the actuators. Aqueous NaPF₆ was applied to the uncoated ends of the actuator and allowed to wick down the length of the actuator. The actuators were cycled from 1.4 to −1.4V. The silicone coated actuator was successfully actuated, while the acrylic coated actuator failed to actuate since the acrylic was too rigid and did not adhere well to the actuator. The silicone coated film dried out after three hours.

### EXAMPLE 3

### Linear Actuator

Linear actuator components were prepared as follows. Films were synthesized by depositing a solution of 0.05 M tetrabutylammonium hexafluorophosphate (Aldrich 98%), 0.06 M distilled polypyrrole (Aldrich), and 1% water in polycarbonate on a glassy carbon crucible. Before deposition, the glassy carbon was polished using a one micron diamond scrub followed by polishing with jewelers' rouge. The polypyrrole-PF₆ material was deposited galvanostatically at 0.125 mA/cm² for 8 hours to produce a film with a thickness of about 11.2 μm. The dimensions of the films were about 26 mm long×4 mm wide×11.2 μm thick.

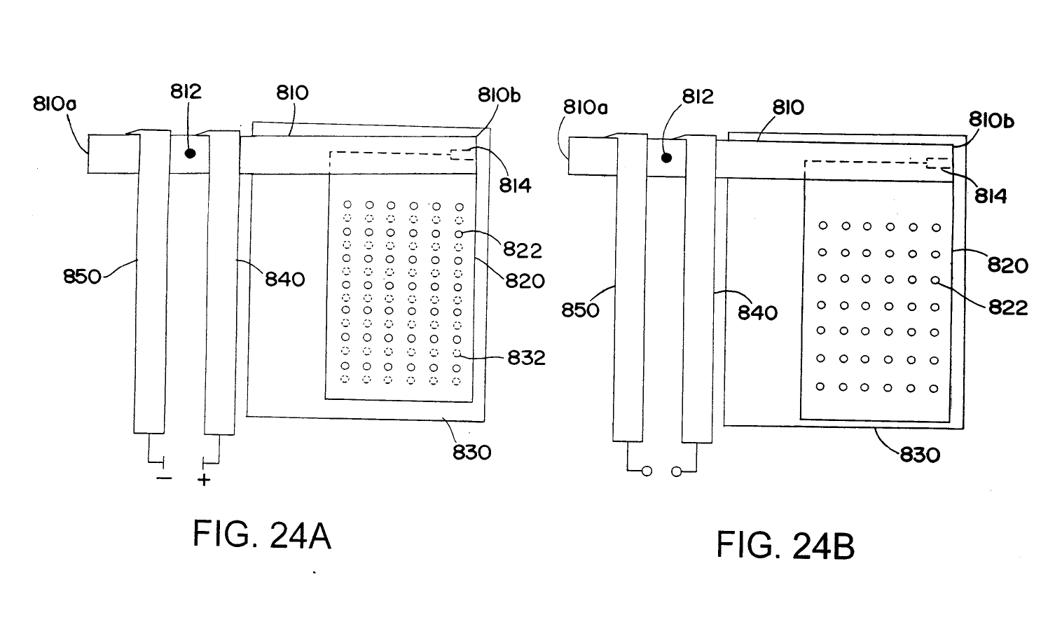

The actuator films in this example were tested with a sliding valve mechanism, as illustrated in FIGS. 24A and 24B. In this case, a lever arm 810 was attached to one end of a first metal plate 820. The first metal plate 820 was positioned adjacent to a second plate 830. The lever arm 810 included a pivot point 812 located near an end 810a of the lever arm opposite to the end 810b of the lever arm that was attached to the first plate 820 via attachment 814. A polypyrrole film was looped around the lever on opposite sides of the pivot point, and the ends of each strip 840, 850 were clamped to the second plate (clamp not shown). The films sat in a solution of aqueous sodium hexafluorophosphate and electrical contact was made at the bottom of the films. The valve had a mechanical amplification of 10×. The voltage was stepped between 1.275 V and −1.275 V, and the valve exhibited a displacement of 2.6 mm, which represents a strain of about 1%. When the voltage was stepped between 1.27 V and 0 V, the valve exhibited a displacement of about 1.5 mm against an estimated frictional force of 0.2 N. FIG. 24A shows the valve in the closed position in which apertures 822 of plate 820 are not aligned with apertures 832 of plate 830, and FIG. 24B shows the valve in an open position with the apertures aligned. The valve is moved from a closed position to an open position by contraction of film 840, and is moved from an open position to a closed position by contraction of valve 850.

While the disclosed technology has been described in detail herein in accordance with certain exemplary embodiments thereof, the scope of the appended claims is not intended to be limited to such embodiments. Further, upon reading and understanding the present application, modifications and changes may occur to those skilled in the art without departing from the spirit of the disclosed technology. It is intended that the disclosed technology be considered as including all such modifications and changes insofar as they come within the scope of the appended claims or the equivalents thereof.

What is claimed is:

1. A battery comprising:
a cell housing having at least one fluid entry port;
a first electrode disposed within the cell housing;
a second electrode disposed within the cell housing; and
a fluid regulating system disposed so as to selectively allow fluid to enter into the at least one fluid entry port, the fluid regulating system comprising:
a valve for controlling the rate of passage of the fluid to one or both of the first and second electrodes, and
an actuator for operating the valve, the actuator comprising at least one conducting polymer, at least one ionic polymer-metal composite, or combinations of two or more thereof.

2. The battery according to claim 1, wherein the valve is formed by the actuator.

3. The battery according to claim 2, wherein the valve comprises an actuator sheet disposed about the at least one entry port so as to cover the at least one entry port when the valve is in a closed position.

4. The battery according to claim 3, wherein the valve is opened by applying a voltage across the actuator such that at least a portion of the actuator sheet is displaced away from the at least one entry port and the fluid can move through the entry port.

5. The battery according to claim 1, wherein the valve comprises a plate disposed adjacent an outer surface of the cell housing, the plate being moveable relative to the outer surface of the cell housing and having at least one aperture for communicating with the at least one entry port when the at least one aperture is moved into alignment with the at least one entry port, and the actuator operates the valve by moving the plate upon application of a voltage across the actuator.

6. The battery according to claim 1, wherein the actuator comprises at least one conducting polymer chosen from polypyrrole, at least one polypyrrole derivative, polyacetylene, at least one polyacetylene derivative, polyaniline, at least one polyaniline derivative, polyphenylene, at least one polyphenylene derivative, polythiophene, at least one polythiophene derivative, polyethylenedioxythiophene, at least one polyethylenedioxythiophene derivative, polyphenylenevinylene, at least one polyphenylenevinylene derivative, polyphenylenesulfide, at least one polyphenylenesulfide derivative, polyfluorence, at least one polyfluorene derivative, poly(p-pyridine), at least one poly(p-pyridine) derivative, poly(p-pyridalvinylene), at least one poly(p-pyridalvinylene) derivative, polythiophenevinylene, at least one polythiophenevinylene derivative, polyfuran, at least one polyfuran derivative, or mixtures of two or more thereof.

7. The battery according to claim 6, wherein the conducting polymer further comprises at least one ion chosen from tetrafluoroborate, trifluoromethanesulfonate, hexafluorophosphate, dodecylbenzene sulfonic acid, nitrate, methylsulfonate, or mixtures of two or more thereof.

8. The battery according to claim 1, wherein the actuator comprises at least one conducting polymer chosen from polypyrrole, at least one polypyrrole derivative, or mixtures of two or more thereof.

9. The battery according to claim 8, wherein the polypyrrole, the at least one polypyrrole derivative, or both the polypyrrole and the at least one polypyrrole derivative further comprises at least one hexafluorophosphate ion.

10. The battery according to claim 1, wherein the actuator comprises at least one conducting polymer and is operated in an electrolyte comprising, sodium chloride, sodium acetate, sodium hexafluorophosphate, 1-butyl-3-methyl imidazolium tetrafluoroborate, at least one phosphonium based ionic liquid, at least one imidazolium based ionic liquid, or mixtures of two or more thereof.

11. The battery according to claim 1, wherein the actuator comprises a first conducting polymer component for opening the valve, and a second conducting polymer component for closing the valve.

12. The battery according to claim 11, wherein the first conducting polymer component, the second conducting polymer component, or the first conducting polymer component and the second conducting polymer component comprise polypyrrole, at least one polypyrrole derivative, or mixtures of two or more thereof.

13. The battery according to claim 1, wherein the valve comprises two adjacent plates, each having a plurality of corresponding apertures that align when the valve is open.

14. The battery according to claim 13, wherein the actuator is capable of exerting a force of at least 0.25 N.

15. The battery according to claim 1, wherein the battery is a sole source of power to operate the valve.

16. The battery according to claim 1, wherein the battery provides at least a portion of the power to operate the valve.

17. The battery according to claim 1, further comprising a control circuit to optionally provide additional power to operate the valve.

18. A battery comprising:
a cell housing having at least one fluid entry port for the passage of a fluid into the cell housing;
a first fluid consuming electrode disposed within the cell housing;
a second electrode disposed within said cell housing; and
a fluid regulating system disposed so as to selectively allow fluid to enter into the at least one fluid entry port so as to reach the first fluid consuming electrode, the fluid regulating system comprising:
a valve for adjusting the rate of passage of the fluid into the fluid consuming electrode, the valve comprising an actuator overlying the at least one entry port, the actuator comprising (i) a first actuator layer comprising at least one conducting polymer, (ii) a second actuator layer comprising at least one conducting polymer, and (iii) a separator disposed between the first and second actuator layers.

19. The battery according to claim 18, wherein the first actuator layer, the second actuator layer, or the first actuator layer and the second actuator layer comprise polypyrrole, at least one polypyrrole derivative, or combinations of two or more thereof.

20. The battery according to claim 18, wherein the actuator is encapsulated by an encapsulation layer.

21. The battery according to claim 20, wherein the encapsulation layer comprises a substantially conformable film.

22. The battery according to claim 20, wherein the encapsulation layer comprises silicone, parylene, or a mixture thereof.

23. The battery according to claim 20, wherein the encapsulation layer has a thickness of from 0.1 μm to 10 μm.

24. The battery according to claim 18, wherein the actuator covers the at least one entry port when the valve is in a closed position, and, upon applying a potential across the actuator, at least a portion of the actuator is displaced away from the entry port to an open position such that the entry port is at least partially uncovered.

25. The battery according to claim 24, wherein the actuator returns to a closed position upon changing the potential applied across the actuator.

26. The battery according to claim 24, wherein the actuator is moveable to a first open position that is intermediate a fully open position and the closed position.

27. The battery according to claim 24, wherein the battery is a sole source of power to operate the valve.

28. The battery according to claim 18, further comprising an oil layer disposed between the actuator and the entry port to facilitate sealing between the valve and the fluid entry port when the valve is in a closed position.

29. A battery cell comprising:
a housing comprising a plurality of entry ports arranged substantially in a first row;
a first fluid consuming electrode disposed within the cell housing;
a second electrode disposed within the cell housing; and
a fluid regulating system, the fluid regulating system comprising a valve for adjusting the rate of passage of the fluid into the fluid consuming electrode, the valve comprising an actuator sheet comprising at least one conducting polymer, at least one ionic polymer-metal composite, or mixtures of two or more thereof;
wherein the actuator sheet is dimensioned to cover the first row of entry ports when the valve is in a closed position, and the valve is moveable to an open position by applying a voltage across the actuator so as to cause at least a portion of the actuator sheet to be displaced away from at least one entry port.

30. The battery cell according to claim 29, wherein the actuator sheet has a length and a width, the length being disposed generally parallel with the first row of entry ports, and the valve is moveable to an open position by the actuator sheet being displaced along the length of the actuator sheet.

31. The battery cell according to claim 29, wherein the actuator sheet has a length and a width, the length being disposed generally parallel with the first row of entry ports, and the valve is moveable to an open position by the actuator sheet being displaced along the width of the actuator sheet.

32. The battery cell according to claim 29, further comprising an oil layer disposed between the actuator sheet and the entry ports to facilitate sealing when the valve is in the closed position.

33. The battery cell according to claim 29, wherein the battery cell is the sole source of power to operate the valve.

34. The battery cell according to claim 29, wherein the actuator sheet comprises polypyrrole, at least one polypyrrole derivative, or mixtures of two or more thereof.

35. The battery according to claim 29, wherein the actuator sheet is encapsulated by an encapsulation layer.

36. The battery according to claim 35, wherein the encapsulation layer comprises a substantially conformable film.

37. The battery according to claim 35, wherein the encapsulation layer comprises silicone, parylene, or a mixture thereof.

38. The battery according to claim 35, wherein the encapsulation layer has a thickness of from 0.1 μm to 10 μm.

39. A battery comprising:
at least one fluid consuming cell comprising:
a cell housing comprising at least one fluid entry port for the passage of fluid into the cell,
a first fluid consuming electrode disposed within the cell housing, and
a second electrode within the cell housing; and
a fluid regulating system comprising:
a valve for adjusting the rate of passage of the fluid to the fluid consuming electrode, the valve comprising (i) a first plate having a first end and a second end opposite the first end, the first plate being stationary relative to the at least one fluid consuming electrode, and (ii) a second plate, the second plate being moveable relative to the first plate so as to open and close the valve, and
an actuator system for operating the valve, the actuator system comprising (i) a first actuator for opening the valve, the first actuator having opposing ends, one end being attached to the second plate, and the other end being attached to the first plate adjacent the first end of the first plate, and (ii) a second actuator for closing the valve, the second actuator having opposing ends, one end of the second actuator being attached to the second plate, and the other end of the second actuator being attached to the first plate adjacent the second end of the first plate,
wherein the first and second actuators each comprise at least one conducting polymer component.
